(19) United States
(12) Patent Application Publication
(10) Pub. No.: US 2017/0059365 A1
(43) Pub. Date: Mar. 2, 2017

(54) Wireless sensing

(71) Applicant: Pabellon, Inc., Richmond, CA (US)

(72) Inventors: Alejandro Victorio Rubin, Gilroy, CA (US); Robert Thomas Martin, Cupertino, CA (US)

(21) Appl. No.: 14/999,361

(22) Filed: Apr. 25, 2016

Related U.S. Application Data
(60) Provisional application No. 62/283,265, filed on Aug. 24, 2015.

(51) Int. Cl. G01D 5/20; H02J 7/02; H02J 50/12

(52) U.S. Cl. CPC G01D 5/2006; H02J 50/12; H02J 7/025

(57) ABSTRACT

A device and system for sensing disturbance in a field. A sensor system comprises an RF power source coupled to one or more emitters producing a field. Measuring the coupling between the source and the emitters for example by measuring forward and/or reverse power allows disturbances caused by objects in the field to be detected. Sweeping the operating frequency of the rf source over a frequency range, or making measurements at frequencies within such a range provides for further characterization of any objects within the field. Placing emitters within a structure allows for characterization of the contents of the structure and detection of changes from such characterization.

### CROSS-REFERENCE TO RELATED APPLICATIONS

This application claims priority to U.S. Provisional Patent Application No. 62/283,265, entitled “Heating of thermal-resistive fabrics and films via alternating electric currents and magnetic fields,” filed Aug. 24, 2015, the disclosure of which is incorporated herein by reference.

Additionally, the disclosure herein references, U.S. Utility Patent Application No. 20130175872, entitled “Improved Power Transmission,” filed Dec. 18, 2012, the disclosure of which is incorporated herein by reference; U.S. Provisional Patent Application No. 61/631,633, entitled “Pabellon effect wireless power transfer using electronically small resonant elements for near field tunneling,” filed Jan. 9, 2012, the disclosure of which is incorporated herein by reference; U.S. Provisional Patent Application No. 61/957,618, entitled “Wireless data and power transmission,” filed Jul. 8, 2013, the disclosure of which is incorporated herein by reference; and U.S. Provisional Patent Application No. 62/176,514, entitled “Wireless Power Transfer and Applications Thereof,” filed Feb. 20, 2015.

The disclosure herein references co-pending U.S. Utility Patent Application No. xx/xxx,xxx entitled “Wireless Data Transfer,” filed April, 2016, the disclosure of which is incorporated herein by reference; and co-pending U.S. Utility Patent Application No. xx/xxx,xxx entitled “Wireless Sensing,” filed April, 2016, the disclosure of which is incorporated herein by reference.

### BACKGROUND

Field of the Invention

The present invention relates generally to wireless power transfer and applications thereof, particularly as relating to wireless sensing.

Description of the Prior Art

The goal of wireless power transfer is to transmit power between a source and one or more sinks through a field generated by the source, without the use of direct electrical connections between the source and the sink(s). Improvements to such power transfer systems look to improving overall efficiency, distance, or both.

Wireless power transfer between a source and a sink without direct electrical connections between source and sink uses electric (E) fields and/or magnetic (B) fields generated by the source and harvested by the sink.

Such power transfer according in the art may be characterized by the type of coupling between the source and sink. Coupling using electric fields is achieved through capacitive coupling in which conductive elements are separated by a dielectric material as is known in the art.

Three broad categories of coupling using magnetic fields known in the art are: transformer coupling, inductive coupling, and resonant inductive coupling. An important aspect of each type of coupling is the distance between source and sink over which power transfer is efficient or effective.

In transformer coupling, a source coil and a sink coil are tightly coupled to a common core. In the case of transformers, the source coils and sink coils are commonly referred to as primary and secondary, respectively. At low frequencies, transformers use magnetic materials such as iron, steel, or ferrites for cores. Air-core transformers are used for higher frequencies. Transformer coupling is very efficient but requires primary and secondary to be fixed on a common core.

Inductive coupling may be thought of as a transformer with a separate primary coil and a separate secondary coil, which do not share a common core. Examples of inductive coupling include devices such as rechargeable electric toothbrushes and devices adapted to use charging mats. In a rechargeable electric toothbrush, the transmit (Tx) coil is mounted in a base unit into which the electric toothbrush body is inserted; the electric toothbrush body contains the receive (Rx) coil which recovers power from the magnetic field produced by the transmit coil. Power from the receive coil in the form of alternating current is converted to direct current to recharge a battery in the electric toothbrush.

In charging mat schemes such as the Qi® standard or the Duracell Powermat®, the charging device contains electronics which energize a transmit coil to produce a varying magnetic field. Devices to be charged, such as smart phones or other devices must be adapted for charging, contains a receive coil and circuitry to convert the alternating current (a/c) induced in the receive coil to direct current (d/c) to charge the device. The receive coil and other circuitry for charging the device must be integrated into the device, or provided through the use of an accessory such as a plugin accessory or case containing the receive coil and the charging circuitry. The device to be charged must be placed precisely and continuously on the charging device for charging to take place. For inductive coupling, the transmit and receive coils must remain closely aligned, with maximum separation within the millimeter range for efficient power transfer.

In resonant inductive coupling, a transmit coil is configured to resonate at a single chosen operating frequency. And an alternating current is fed to the transmit coil at this frequency. The transmit coil can self-resonant, where the inductance and self-capacitance of the transmit coil determine the resonant frequency, or the transmit coil can be made to resonant by adding a capacitor in series with or in parallel to the transmit coil. When driven at the resonant frequency, the transmit coil is said to ring, generating an increasing oscillating magnetic field. The receive coil must be resonant at this same frequency as the transmit coil.

Resonant inductive coupling can transfer power over the electromagnetic near field, defined in terms of the wavelength of the resonant operating frequency, and is in the range of the wavelength at this resonant operating frequency divided by two Pi. Even in this near field, efficiency in resonant inductive coupling falls off at a rate proportional to one over the distance between transmitter and receiver to the fourth power.

Common methods to increase the efficiency of resonant inductive coupling, include using air core coils, to eliminate losses caused by magnetic cores, and using physically large coils with a small number of turns, to reduce resistive losses. This higher efficiency, measured electrically as the Quality factor (Q), of a tuned circuit results in a reduced bandwidth or operating frequency range. Thus, requiring both the transmit and receive coils to be critically tuned to the same frequency. Such high Q air-core coils, when operating in the one to fifteen megahertz (MHz) frequency range, may be a meter or more in diameter. As such, Q air-core coils provide power transmission over a range of only a few meters, and only operate over a very narrow bandwidth.

In summary, transformer coupling is efficient but requires fixed, closely coupled transmit and receive coils on a shared core. Inductive coupling may be efficient but requires precise and continuous alignment of transmit and receive coils, which may be separated on the order of millimeters. Resonant inductive coupling can extend the separation of transmit and receive coils to a meter or more but requires physically very large coils and has a very narrow bandwidth, with very poor efficiency.

Given that electrical power can be transferred from a source to one or more sinks, this transfer mechanism can also be adapted for use as a sensor.

### SUMMARY

In one embodiment is provided a sensor system comprising: a source producing RF power, a coupler for coupling the RF source to one or more emitters producing a field, the coupler measuring the coupling between the RF source and the emitters, and a controller measuring the coupling between the RF source and the emitters to detect changes in the field.

In a further embodiment is provided a system where the coupler measures forward RF power.

In a further embodiment is provided a system where the coupler measures reverse RF power.

In a further embodiment is provided a system where the controller detects changes in the field by detecting changes in the coupler measurements.

In a further embodiment is provided a system where the changes in the coupler measurements are made at a fixed frequency.

In a further embodiment is provided a system where the changes in the coupler measurements are made at a plurality of frequencies.

In a further embodiment is provided a system where the changes in the coupler measurements are made by comparing measurements to measurements made in a known state.

In a further embodiment is provided a system where the emitters are placed inside a structure for detecting changes made to the contents of the structure

### BRIEF DESCRIPTION OF DRAWINGS

FIG. 1 is a diagram of a wireless power transfer system according to an embodiment.

FIG. 2 is a diagram of a power generator according to an embodiment.

FIG. 3 is a diagram of an emitter according to an embodiment.

FIG. 4a is a diagram of an emitter according to another embodiment.

FIG. 4b is a diagram of an emitter according to another embodiment.

FIG. 4c is a diagram of an emitter according to another embodiment.

FIG. 4d is a diagram of an emitter according to another embodiment.

FIG. 4e is a diagram of an emitter according to another embodiment.

FIG. 4f is a diagram of an emitter according to another embodiment.

FIG. 5 is a diagram of an emitter according to another embodiment.

FIG. 6 is a diagram of a sink according to an embodiment.

FIG. 7 is a diagram of a sink according to another embodiment.

FIG. 8 is a diagram of a sink according to another embodiment.

FIG. 9 is a diagram of a sink according to another embodiment.

FIG. 10 is a diagram of a sink according to another embodiment.

FIG. 11 is a diagram of harvesting electronics and a load according to an embodiment.

FIG. 12 is a diagram of harvesting electronics according to another embodiment.

FIG. 13 is a diagram of harvesting electronics according to another embodiment.

FIG. 14 is a diagram of harvesting electronics according to another embodiment.

FIG. 15 is a diagram of supplying power to a load according to an embodiment.

FIG. 16 is a diagram of an emitter according to another embodiment.

FIG. 17 is a diagram of a source according to another embodiment.

FIG. 18 is a diagram of a data transfer device according to an embodiment.

FIG. 19 is a diagram of a collector structure according to an embodiment.

FIG. 20 is a diagram of a battery replacement according to an embodiment.

FIG. 21 is a diagram of resonator-sets in in open and closed configurations according to an embodiment.

FIG. 22 is a system diagram according to additional embodiments.

### DETAILED DESCRIPTION OF THE INVENTION

Herein described various embodiments of a system for transferring power wirelessly from a source to one or more sinks. The source comprises a power generating source coupled to one or more emitters. The sink comprises one or more collectors coupled to a resonator coupled to harvesting electronics. The harvesting electronics is configured to provide power to one or more loads. The one or more collectors of the sink are coupled to the one or emitters of the source to transfer power. Given the ability to transfer power from source to sink, the use of this system for data transfer and for sensing as will be described.

In operation, a power transfer system is formed by a source which generates a radio frequency (RF) field. The RF field couples power to one or more sinks. The source comprises a power generator which supplies RF power to one or more emitters. A sink comprises one or more collectors coupled to a resonator. One or more collectors positioned within the RF field is coupled to the emitter(s) and receives RF power. The resonator delivers RF power to the harvesting electronics which convert the RF power to direct current (DC) and provides that DC current to one or more loads. Emitters and collectors are designed so that collectors in the sink, coupled to emitters in the source allows the sink to be moved relative to the emitters without requiring precise positioning, providing power to the load(s).

Note that while the term resonator is used in describing the invention herein, such resonators are not tuned inductor-capacitor (L-C) circuits with a single fixed resonant frequency, but instead are untuned inductors operable over wide frequency ranges.

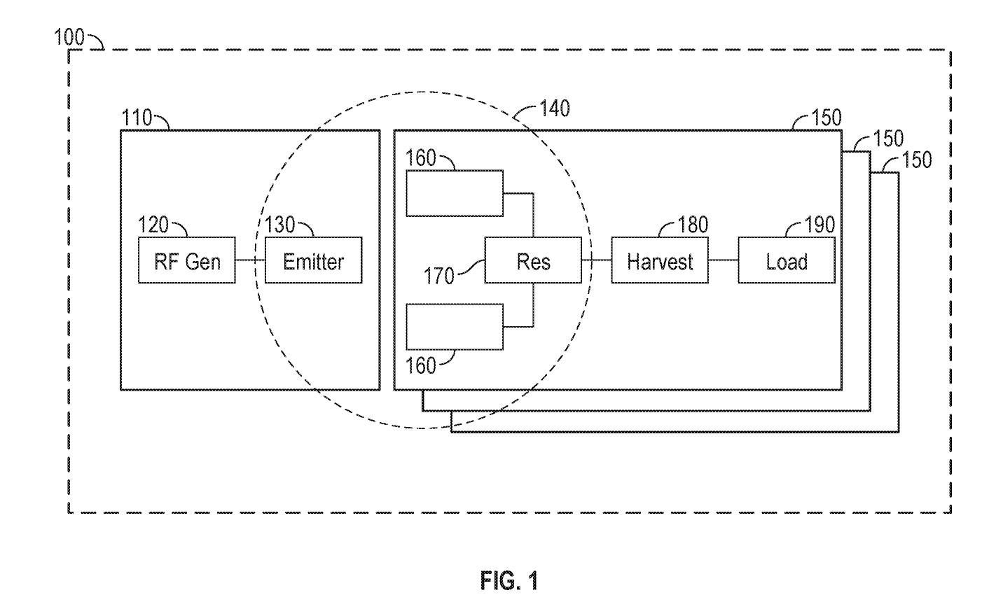

FIG. 1 is a diagram of a wireless power transfer system 100 according to an embodiment. In system 100, source 110 generates field 140 transferring RF power to one or more sinks 150. Source 110 comprises a power generator 120 which supplies RF power to an emitter 130. One or more sinks 150 positioned within field 140 receive RF power from source 110. Sink 150 comprises collectors 160 connected to resonator 170. Resonator 170 delivers RF power to harvesting electronics 180 which convert the RF power to DC and provide that DC current to a load 190. As described further herein, in an embodiment emitters 130 and collectors 160 are designed so that collectors 160 in sink 150 couple to emitters 130 without requiring precise positioning and allowing for sink 150 to be moved with respect to emitters 130 while remaining within field 140 and thus continuing to provide power to load 190 within sink 150.

Note that while FIG. 1 shows a single source 110 transferring power to one or more sinks 150 on a predetermined frequency, multiple sources synchronized on the same frequency may be used to transfer power to one or more sinks operating at that frequency. Similarly, multiple sources 110 operating at different frequencies may transfer power to sinks 150 configured to operate at those different frequencies.

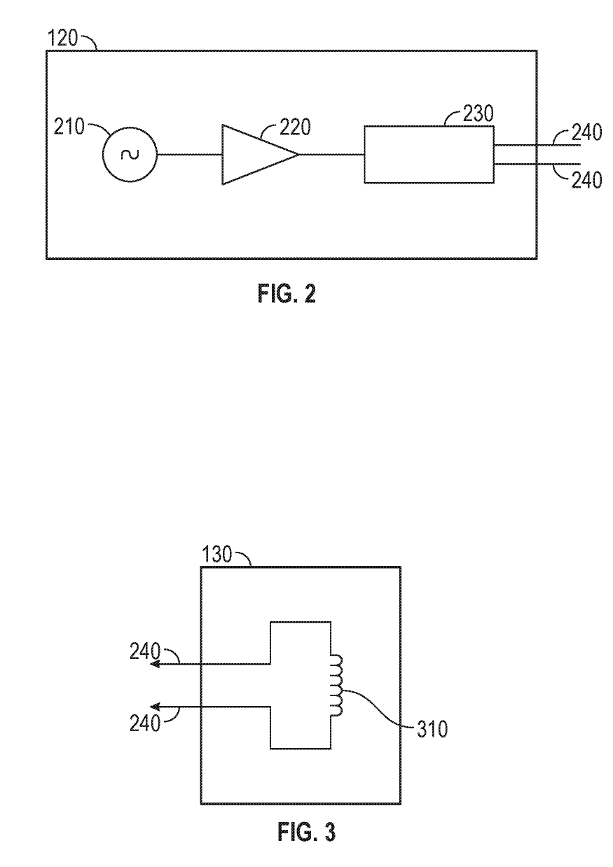

FIG. 2 is a diagram of a power generator according to an embodiment. Power generator 120 comprises signal generator 210 which generates an RF signal. This RF signal is amplified by RF power amplifier 220 producing output 240. Note that this output may be ground referenced, or may be a balanced output. As is known in the art, the output of an amplifier has a characteristic impedance. For best power transfer to a load, the impedance of the load should match the output impedance of the amplifier. Commercial RF power amplifiers commonly have single-ended outputs for use with coaxial cables, and are designed with an output impedance of 50 or 75 Ohms. While a purpose-built RF power amplifier used for RF power amplifier 220 may be constructed with an output impedance chosen to match the impedance of emitter 130, if the output impedance of RF power amplifier 220 is 50 Ohms and the impedance of emitter 130 is not 50 Ohms, a matching network 230 may be required to match the impedance of RF power amplifier 220 to the impedance of emitter 130 to improve power transfer.

In an embodiment, signal generator 210 may be a fixed frequency signal generator such as an oscillator whose output RF frequency is determined by a crystal, ceramic resonator, or other frequency determining network as known in the art. As known in the art and described further herein, signal generator 210 may be a transistor crystal oscillator, a single package crystal oscillator such as the SG-210 STF from Seiko Epson Corporation, or a laboratory signal generator. In another embodiment, signal generator 210 is a frequency-agile device such as a direct digital synthesizer (DDS), or other variable frequency source configured to generate the required signal.

RF power amplifier 220 amplifies the RF signal produced by signal generator to the power level required for the system. As known in the art, such an RF power amplifier may range in complexity from a single transistor amplification stage to a commercial RF power amplifier. As is known in the art and described further herein, RF power amplifiers are designed with a characteristic output impedance, commonly 50 Ohms. Emitter 130 of the present invention typically does not have a 50 Ohm impedance. Matching network 230 matches the output impedance of RF power amplifier 220 to output 240 which connects to emitter 130. Among the matching networks known in the art is a Pi-network which comprises an input capacitor connected across the output of RF power amplifier 230, an output capacitor connected across output 240, and an inductor connected between the input capacitor and the output capacitor. The values of the capacitors and the inductor are chosen to provide a good impedance match and may be variable. Where such filtering is not required, a transformer may be used as a matching network. Note that while impedance matching improves power transfer, precise matching may not be required.

It is important to note that the systems of the present invention operate over a range of frequencies, and are not restricted in operation to a fixed frequency such as is the case in resonant inductive coupling systems. Sinks can operate over a range of frequencies and are not limited to a single operating frequency as is the case with systems such as resonant inductive coupling. Regulatory concerns, however, suggest the use of a single frequency band for the operation of sources. One such frequency band is the 13.56 Megahertz (MHz) band, which is part of an internationally recognized frequency band dedicated to industrial, scientific, and medical (ISM) use as defined by ITU Radio Regulations known in the art. Other ISM frequencies may also be used, including but not limited to 6.78 MHz and 27.120 MHz. Similarly, regulatory concerns such as spectral purity requirements imposed by the United States Federal Communications Commission (FCC) require that harmonics of a signal generated by a system must not exceed limits specified in regulations such as FCC Part 15 and/or Part 18. Matching network 230 may be constructed to not only provide the required impedance matching between RF power amplifier 220 and emitter 130, but also to provide a filter such as a low-pass or bandpass filter to reduce harmonics of the operating frequency generated by signal generator 210 and RF power amplifier 220 to meet regulatory limits.

In an embodiment for laboratory use, power generator 120 comprises a signal generator 210 such as the Agilent 33250A, Hewlett Packard 3314A, or similar signal source. This signal generator 210 drives an RF power amplifier such as an ENI 320L or ENI 325LA from Electronics & Innovation, Ltd., or similar RF power amplifier. Matching network 230 may be a commercially available matching network such as the MFJ 902B antenna tuner from MFJ Enterprises, Inc. The matching network may be adjusted as is known in the art by placing a directional coupler and standing wave ratio (SWR) meter such as the MFJ 822 between RF power amplifier 220 and matching network 230 and adjusting matching network 230 for maximum forward power and minimum reverse power. The standing wave ratio (SDR) is a function of forward and reverse power, and is known in the art.

It should be noted that a perfect impedance match between power generator 120 and emitter 130, which would be indicated by a standing wave ratio (SWR) of 1:1 as known in the art is desirable, in practice a SWR of 3:1 or less is acceptable, and depending on the power levels, higher SWR values may also be acceptable.

In another embodiment, power generator 120 comprises a crystal oscillator operating at a fixed frequency such as 13.56 MHz for signal generator 210. This may be a single transistor oscillator, a single package crystal oscillator such as the SG-210 STF from Seiko Epson Corporation, or other suitable oscillator known in the art. While other oscillator embodiments may be used, such as LC resonant oscillators known in the art, frequency stability requirements suggest the use of a crystal or similar resonator. In an embodiment RF power amplifier 220 is a single ended or push-pull amplifier using one or more metal-oxide-semiconductor field-effect transistors (MOSFETs) such as the STP16NFO6 MOSFET power transistor from ST Microelectronics. Other RF power amplifiers as known in the art may be used.

As is known in the art, RF power amplifiers typically contain an output transformer between the power transistors and the output. Such output transformers are typically designed to have an output impedance of 50 Ohms. The function of matching network 230 may be provided in part by modifying the output transformer to better match the impedance of emitter 130. Such a modification is made by reducing the number of turns on the output winding of such a transformer to lower its impedance, and/or increasing the number of turns on the output winding of such a transformer to increase its impedance, to better match the impedance of emitter 130. Other components such as inductors and capacitors may be added to improve the impedance match and provide filtering as required. In alternate embodiments, a tapped inductor may be used. Capacitive coupling between a power transistor and the output may also be used.

In another embodiment, signal generator 210 in power generator 120 is a frequency-agile device such as a direct digital synthesizer (DDS). A DDS integrated circuit such as the AD9850 from Analog Devices, or the Si5351 from Silicon Labs may be used under the control of a suitably programmed microprocessor. In an embodiment, the ATmega328 from Atmel Corporation may be used. Other microprocessor architectures may also be used, including but not limited to PIC microprocessors from Microchip Technology, and ARM microprocessors manufactured by companies such as Texas Instruments. The computational requirements for controlling a DDS such as the AD9950 or Silicon Labs Si5351 are modest.

In another embodiment signal generator 210 in power generator 120 is a digital signal processor (DSP) integrated circuit. Digital Signal processors are known in the art and are available from companies such as Analog Devices, Texas Instruments, and others. A DSP can be programmed to generate a single frequency, or a plurality of frequencies. Note that the generated frequencies are fundamental frequencies, harmonics may be present as is known in the art.

In environments where multiple frequencies are desired, a number of different embodiments may be used. In one embodiment, separate sources 110, one for each desired frequency, are used. In another embodiment, a single emitter 130 may be driven by the combined output of multiple power generators 120. Power combiners are known in the art. In another embodiment, a single emitter and a single RF power amplifier 220 are driven by the desired multiple frequencies. The multiple frequencies for RF power amplifier 220 in such an embodiment may be produced by combining the outputs of separate signal generators 210, or by directly generating a signal which is the sum of the desired frequencies such as by using DSP techniques known in the art.

The emitter 130 may comprise conductors. The conductors material may be either an electrically conductive material or a magnetically conductive. Or the conductors material may be both electrically and magnetically conductive. Furthermore, the emitter 130 may comprise resonators, same design as the resonator 170. These resonator-emitters are connected to the power generator output 240, in the same manner as emitter 130.

FIG. 3 is a diagram of an emitter 130 according to an embodiment. In this embodiment, emitter 130 is a resonator 310 comprising one or more inductors which connect to the output 240 of power generator 120. An inductor/resonator 310 may be one or more turns of a conductor such as a copper wire or a metal foil. The emitter 130 can be embedded in or on the surface of a non-conductor matrix. As an example, an inductor 310 may be multiple turns of copper wire embedded in a wooden work surface or table. In commercial applications where work surfaces and/or tables are constructed of particle board or similar core material with a finishing veneer, inductor 310 may be placed in the core material such as in a groove, under the finishing veneer. Such construction protects the inductor windings. An inductor 310 may be made using a copper tape or foil. In an embodiment this may be sealed in a plastic substrate to ease installation, or the copper tape or foil may be placed in or on a table or work surface as with the case of a copper wire. Other mounting methods may be used, such as placing emitter 130 in or on walls or wall panels, ceilings or ceiling panels, embedded in decorative frames, and the like. Other conductive metals may also be used, such as Mu metals. As shown, resonator 130 does not include a capacitor either in series or in parallel with inductor 310.

In addition to the emitter 130 being embedded in the non-conductive material, the emitter material can be composited into a non-conductive material matrix. Laboratory test have shown that resins or other materials of particle boards can be used as emitters. The emitter material may also be a fabric or a textile. Examples are conductive materials such as Eeonyx NW-170-PI-15, NW170-PI-20-PV3-A, TDM-PI-36-A and FG-PI-30 from Eeonyx Corporation. In an alternative embodiment, the emitter material may be embedded or interwoven in a fabric or a textile, such as conductive threads in a woven or nonwoven material, or aluminized Kevlar.

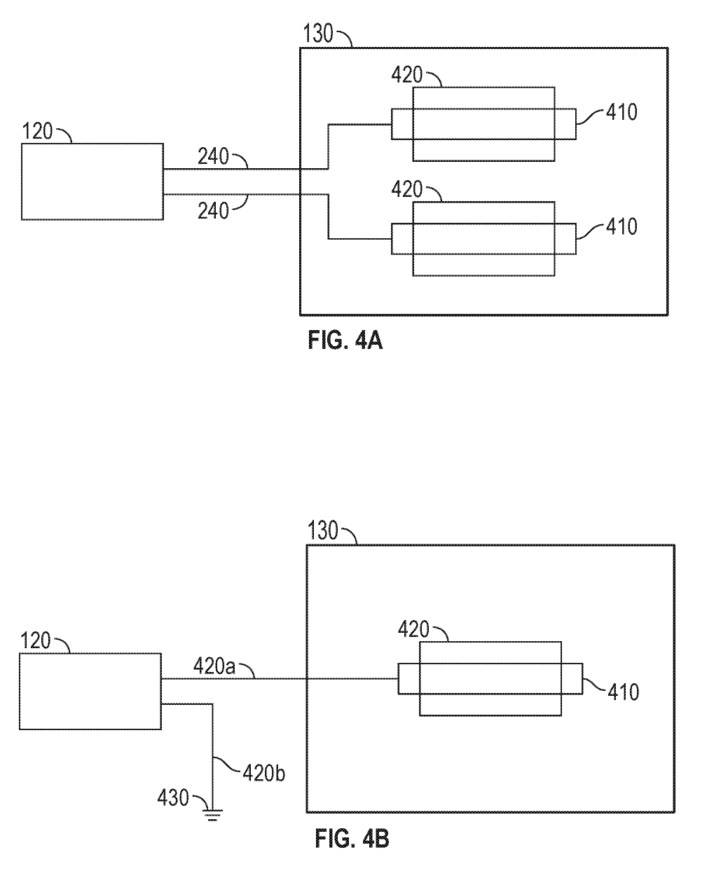

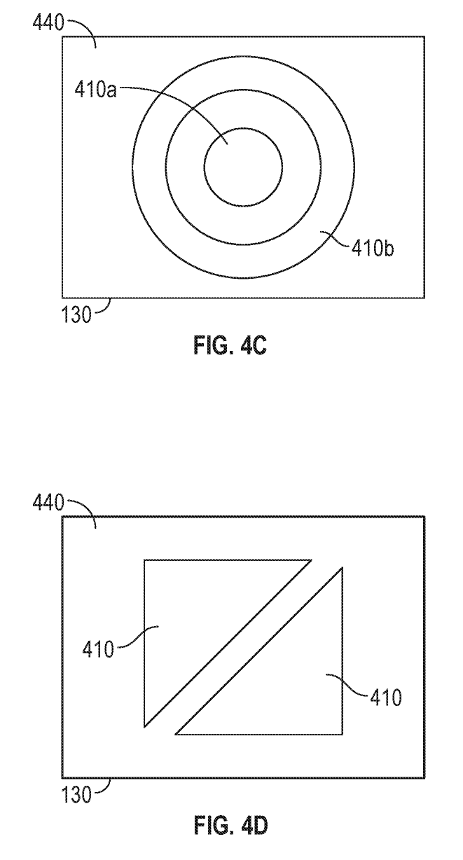

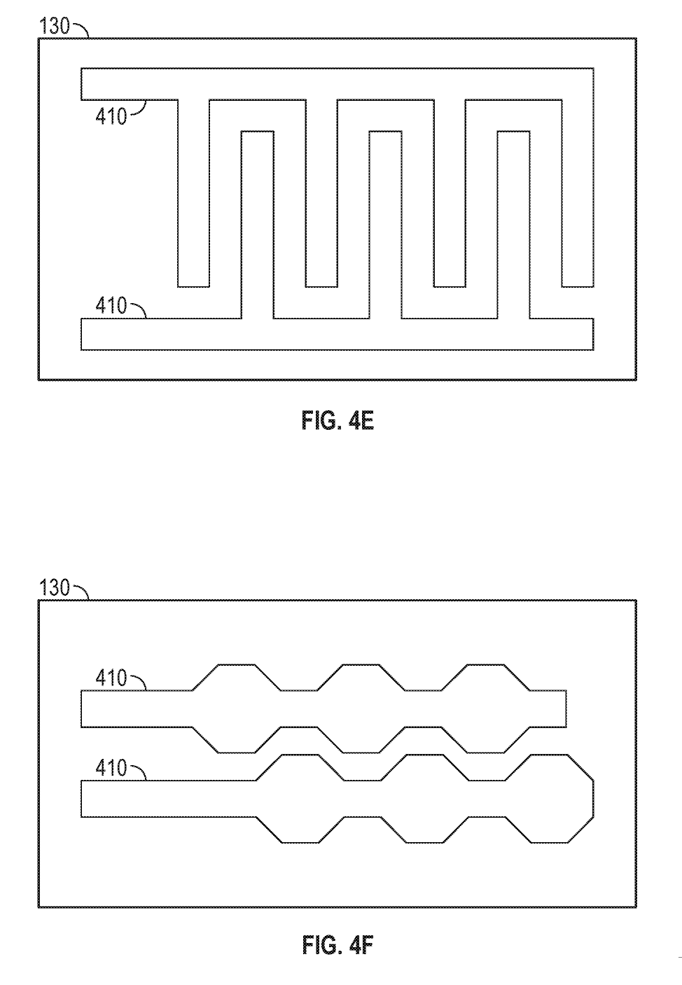

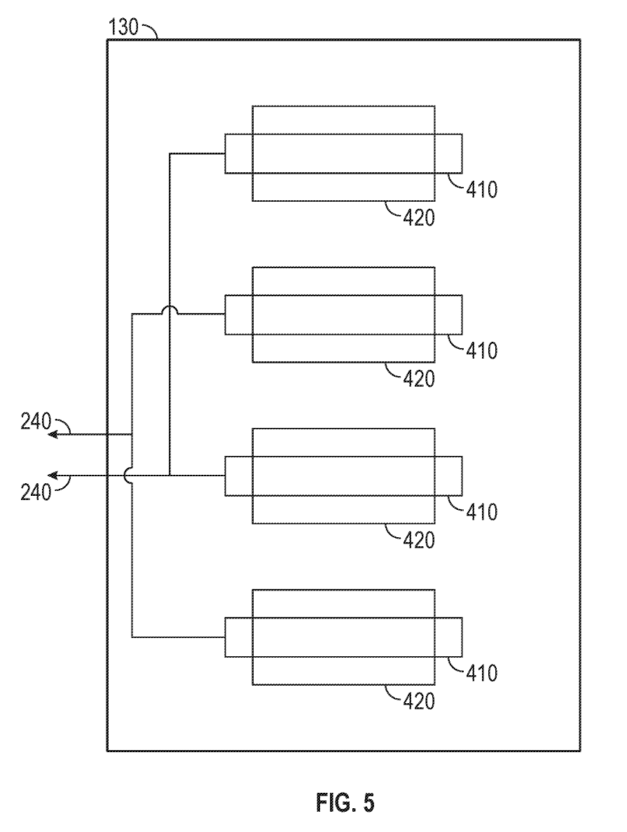

FIGS. 4a, 4b, 4c, 4d, 4e, 4f and 5 show various additional embodiments of emitters 130. Emitters 130 may be coupled to power generator 120 using both outputs 240 coupled to the emitter 130 in a two line feed as shown in FIGS. 4a, 4c, 4d, 4e, and 4f. Emitters 130 may be coupled to power generator 120 using a one line feed in which one output 240 is coupled to the emitter 130 and the other output 240 is connected to an external ground such as shown in FIG. 4b.

Typically, power generator 120 is coupled to an external ground such as wall plug ground for both one line feed and two line feed configurations.

Emitter 130 may take the form of wearables, referring to devices which are worn or associated with a person. These include without limitation watches, rings, pendants, smart devices such as phones and other communications devices, heating devices such as hand or foot warmers, other wearable electronic ornamentation, and sensors. The techniques disclosed herein are adaptable to the wearable environment to provide power and data transfer for such devices.

As an example in the wearable environment, an emitter structure may be formed of sections of conductive material such as a conductive cloth, wire, conductive fiber, or areas of material so treated to be conductive that are embedded in clothing. An example is conductive material introduced into fabric seams of a garment such as a shirt or jacket where such seams provide effective emitter paths down the arms of the garment, across the back, and on the chest. Electronics such as a battery power source and power generator 120 are coupled to the emitter paths, either by direct electrical connection or capacitive coupling. In an embodiment, such electronics may be placed in a backpack, embedded into the garment, worn as a belt or belt pack, or otherwise associated with the garment. According to the techniques disclosed herein, the garment is capable of providing power and communications to wearable devices on the person. By adapting wearable devices as disclosed herein, power and communications paths are available for use by such devices, without requiring wired connections.

FIG. 4a is a diagram of an emitter 130 according to an embodiment. In this embodiment, emitter 130 comprises conductors 410 coupled to each output 240 of power generator 120. In an embodiment, conductors 410 are adhesive-backed copper tape. The width of this tape may be one eighth of an inch or greater. Other conductors such as aluminum tape or conductive coatings may be used. In another embodiment, conductors 410 may be serpentine conductors. Serpentine conductors, or serpentine traces are known in the printed circuit arts and are commonly used to increase trace length in a given space. A serpentine trace is commonly a zigzag trace which increases trace length.

In an embodiment, one or both conductors 410 are coupled to an optional charge mobility element 420. A charge mobility element 420 is a material which promotes electron mobility, such as a metal, semiconductor, electrolyte, plasma, or other resistive material. This coupling may be a direct electrical contact, or it may be a capacitive coupling where the charge mobility element 420 is separated from conductor 410 by an insulating material serving as a dielectric. An example of a charge mobility element 420 is a plastic strip with a conductive coating, such as 3M Conductive Pressure Sensitive Cover Tape 2666 from 3M Corporation. This tape is available in standard widths ranging from 5.4mm to 81.1 mm. In one embodiment, conductor 410 is a metal tape such as a one quarter inch width copper tape. This tape is placed on a substrate and covered with 3M 2666 conductive tape as charge mobility element 420. In another embodiment, conductor 410 is an adhesive-backed copper tape placed on to 3M 2666 conductive tape used as charge mobility element 420. Other conductive tapes may be used for charge mobility element 420, such as Indium Tin Oxide (ITO) and other coated tapes available from various suppliers.

Other conductive materials may be used as a charge mobility element 420. For example, resistive coatings such as Licron Crystal ESD coatings from Tech Spray, or Total Ground carbon conductive coating from MG Chemicals may be used. Other resistive coatings may also be used.

Other conductive elements may also be used for charge mobility element 420, such as an enclosure of a conductive material directly or capacitively coupled to conductor 410. As an example, a conductor 410 may be applied to a container holding a solution such as a salt solution. Different salts, such as sodium chloride (NaCl) or magnesium chloride (MgSO4), may be used. In such an embodiment, charge mobility element 420 is the conductive solution which is capacitively coupled to conductor 410 through the container holding the solution.

In addition to charge mobility elements coupled to emitters and/or collectors, a conductive path may be used between the source and one or more sinks to extend the operation of the system. The conductive path may be loosely or tightly coupled to the source and/or sink. Tight coupling includes direct electrical connection, capacitive, or magnetic coupling. Loose coupling includes placing the conductive path near the collector and/or emitter.

As an example, the wearer of a portable electronic device may also be used as a conductive path, such as by capacitively coupling the source and sink to the skin. Coupling to the skin as a conductive path extends the operation of the system.

Experiment has shown that the presence of charge mobility element 420 coupled to conductor 410 broadens the frequency response of emitter 130 allowing for better matching to power generator 120, and provides for a more stable impedance match of emitter 130 to power generator 210. Efficiency may be increased by coupling multiple charge mobility elements, such as by layering multiple charge mobility elements 420 on a conductor 410.

Other structures may be used as emitters 410 and/or charge mobility elements 420. Experiments have shown that a wide range of conductive materials may be used, including but not limited to metal foils, resin surfaces, piezoelectric sheets, aqueous solutions, fabrics/textiles, and plasmas such as excited fluorescent tubes.

In a structure such as a house, industrial, or commercial structure, elements of the structure may also be used as emitters and/or conductive paths. As examples, elements such as electrical wiring, plumbing, metallized heating and air conditioning ducts, and rebar can serve as emitters and/or a conductive path.

FIG. 4b is a diagram of an emitter 130 according to another embodiment and shows an emitter 130 using a single line feed from power generator 120. In this embodiment one output 240 of power generator 120 connects to an external ground 430. An example of an external ground 430 is the electrical ground provided in household or industrial AC power distribution. In an embodiment, this ground connection may be provided by the power supply (not shown) operating power generator 120 as a direct or capacitive coupling to the AC power for the power supply. The other output 240 of power generator 120 is connected to conductor 410 of emitter 130. In an embodiment such as an industrial building, emitter 130 may be built into a wall or wall covering and may be many meters in length, providing power, or as described further herein, sensor and/or data capabilities.

In another embodiment in a transportation vehicle such as an automobile, truck, bus, aircraft, ship, or other transportation vehicle, the conductive frame, chassis, and/or shell of the vehicle is used as the external ground 430. For example in an automobile, the conductive frame and conductive portions of the body may be used as the external ground 430, with conductor 410 being placed in the interior of the vehicle such as in the headliner, door panels, center console, seats, or other interior structures to provide for operation of sinks 150 as described herein. In an aircraft, the conductive frame and conductive portions of the body may be used as the external ground 430, with conductor 410 being placed for example on tray tables or other associated surfaces.

FIG. 4c is a diagram of an emitter 130 according to another embodiment. A central circular conductor 410a on a substrate 440 is surrounded by an annular conductor 410b. Shapes other than circular shapes may be used. Such an embodiment may be used for example in sensor applications, and/or in supporting wearable devices.

FIG. 4d is a diagram of an emitter 130 according to another embodiment. Triangular conductors 410 are on substrate 440.

FIG. 4e is a diagram of an emitter 130 according to another embodiment and shows interdigitated conductors 410.

FIG. 4f is a diagram of an emitter 130 according to another embodiment and shows a variation of interdigitated conductors 410.

FIG. 5 is a diagram of an emitter 130 according to another embodiment. In this embodiment, similar to the embodiment of FIG. 4, a plurality of emitter elements each consisting of a conductor 410 and a charge mobility element 420 are used. As shown, emitter elements are interleaved and connected to output 240 of power generator 210.

The emitter embodiments of FIGS. 4 and 5 may be integrated into the working environment. As an example, emitter elements comprising conductors 410 and optional charge mobility elements 420 may be applied to the bottom of a table or work surface. Similarly, emitter elements may be embedded in the work surface, such as between a particle board or other core material and a finishing layer of the work surface, or on the rear surface of a finishing material applied to a base or support material. Emitter elements may be applied to or embedded in a support structure such as a paper or plastic sheet. Emitter elements may be applied to or integrated into other structures found in the environment such as wallboard, work surfaces, wall and/or divider panels seating structures, or the like. Such emitters may be used not only for power transfer, but also for sensor and data transfer.

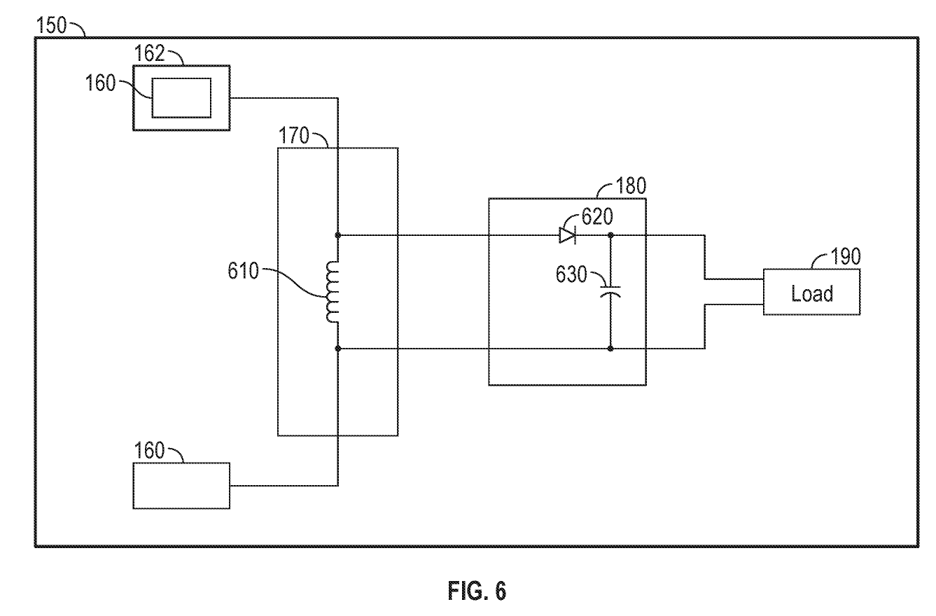

FIG. 6 is a diagram of a sink according to an embodiment. One or more sinks are powered by a source 110. Referring to FIG. 1, sink 150 comprises collectors 160 coupled to resonator 170. Collectors 160 are coupled to emitters 130 of source 110, not shown. Resonator 170 delivers RF power to harvesting electronics 180 which convert the RF power to DC and provide that DC power to a load 190.

Collectors 160 are conductive elements similar to emitters 130 previously described. The conductors material may be either an electrically conductive material or a magnetically conductive. Or the conductors material may be both electrically and magnetically conductive. Furthermore, the collectors may comprise resonators 170. The resonators 170 are inductors connected to the harvesting electronics 180. In embodiments, wires, metal strips, metal elements, Mu metals, traces on printed circuit boards such as serpentine traces, and other conductive elements may be used as collectors 160. In embodiments where conductive surfaces or elements are available in load 190, these may be used as one or more collectors 160. For example a conductive surface on a portable device such as a watch, smart phone, or other device may be used as a collector 160. The case of a device, or a conductive portion of a case may be used as a collector 160. Objects such as batteries, for example a lithium ion power source in a watch or tablet may be used as a collector 160. Experiments have shown that the material used, shape, and configuration such as length and size of collectors 160 play a role in tuning sink 150 to operate at a particular frequency, as well as the size and composition of load 190.

In addition, the collector 160 may be embedded in a non-conductive material. The collector conductive material can be composited into the non-conductive material matrix. Laboratory test have shown that resins or other materials of cellphone cases can become collectors. The collector material may also be a fabric/textile. Examples are Eeonyx NW-170-PI-15, NW170-PI-20-PV3-A, TDM-PI-36-A and FG-PI-30 from Eeonyx Corporation. Or the collector material may be embedded or interwoven in a fabric/textile, such as aluminized Kevlar.

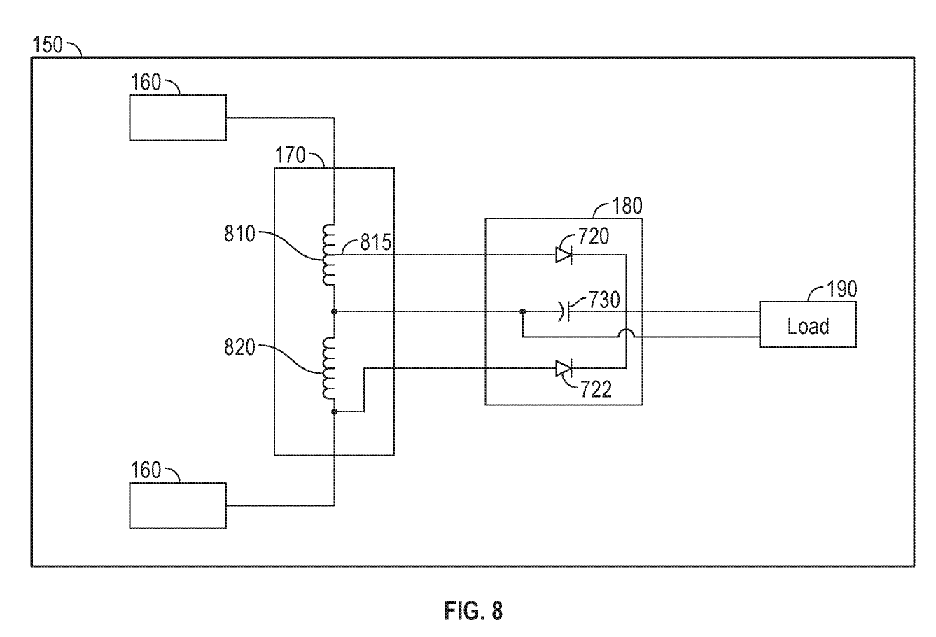

Optionally coupled to collector 160 is charge mobility element 162. Note that charge mobility elements 162 may be used in any of the embodiments described herein. Similar to the charge mobility elements 420 of the emitters 130 of FIGS. 4 and 5, charge mobility element 162 of FIG. 8 is a resistive element coupled to collector 160. This coupling may be a direct electrical connection between collector 160 and charge mobility element 162, or may be a capacitive coupling between collector 160 and charge mobility element 162. Collector charge mobility elements 162 are essentially the same as the emitter charge mobility elements 420. Examples of collector charge mobility elements are 3M Conductive Pressure Sensitive Cover Tape 2666, Indium Tin Oxide (ITO) coated tapes, and resistive coatings such as Licron Crystal ESD coatings, or Total Ground carbon conductive coating. A non-conductive material in which a collector 160 is embedded or composited may also serve as a charge mobility element,

Additionally, similar to the emitter charge mobility element 420, the wearer of a portable electronic device may also be used as the collector charge mobility element 162, such as by capacitively coupling to the skin.

The material and purpose of the charge mobility elements 420 for the emitters 130 and charge mobility elements 162 for the collectors 160 are essentially the same. Although in operation, they need not match for a particular system.

In another embodiment, resonators 170 may be used as collectors 160. Tuning of a sink 150 for operation at a particular frequency can be accomplished by adjusting the vertical gap and lateral overlap between the two resonators 170 used as collectors 160. Charge mobility elements 162 can be used with such embodiments. Furthermore, lower frequencies and greater distance may be achieved with a longer resonator length, more resonators within the resonator-set(s), and/or larger collector(s), more collectors 160 attached to the coil-set(s) of the resonator. A plurality of resonators and/or increase in resonator length and/or an increase in the collector size will achieve lower frequencies power transmission, thus longer range. The increase in the collector 160 may be in both the surface area or volume or both, in two dimensional or three dimensional form.

In the embodiment of FIG. 6, resonator 170 is a single inductor 610.

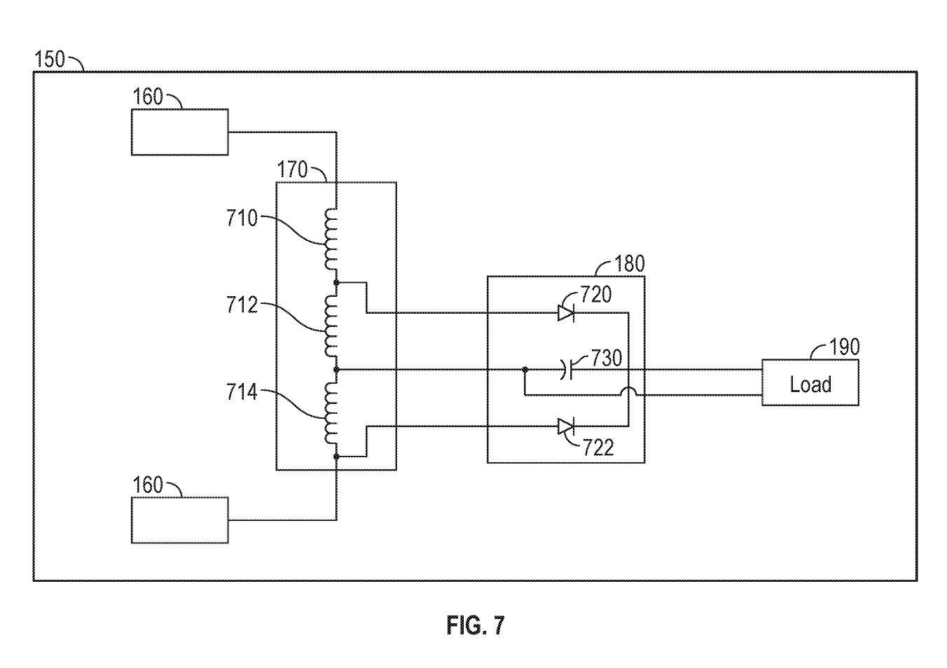

FIG. 7 is a diagram of a sink 150 according to another embodiment. In this embodiment, resonator 170 comprises three inductors 710, 712, 714 connected in series with collectors 160 connected as shown. Harvesting electronics 180 comprises a full wave rectifier using diodes 720 and 722 and filter capacitor 730. The junction of inductors 712 and 714 is treated as a center tap, with diodes 720 and 722 connected to inductors 712 and 714 as shown. In an embodiment, inductors 710, 712, 714 are printed circuit board traces. Trace lengths ranging from 0.1 meters to 4 meters have been used for inductors 710, 712, 714. When fabricated on a printed circuit board, inductors 710, 712, 714 may be coplanar, that is, fabricated on the same substrate. It should be noted that wire wound inductors may also be used. In some embodiments, inductors 712 and 714 may be connected in parallel.

An advantage is gained by having inductor 710 magnetically coupled to either or both of inductors 712 and 714. One such implementation stacks inductor 710 co-axially with either or both of inductors 712 and 714. This may be done for example by constructing inductors 710 and 712 and/or 714 using multi-layer printed circuit board fabrication techniques. While an advantage is gained in having inductor 710 coupled to one or both of inductors 712, 714, this is not required. Inductors 710, 712, 714 do not have to be magnetically coupled or co-planar.

FIG. 8 is a diagram of a sink 150 according to another embodiment. This embodiment may be visualized as the embodiment of FIG. 7 with separate inductors 710 and 712 implemented as a single tapped inductor 810. This embodiment gains the advantage of having inductors 710 and 712 of FIG. 7 closely coupled by replacing them with a single tapped inductor 810. Harvesting electronics 180 in the form of a full wave bridge as used in FIG. 7, connected to the tap 815 on inductor 810, the junction of inductors 810 and 820, and the junction of inductors 820 and collector 160. Note that the tap point may be adjusted to assist in tuning the resonator structure and its interaction with collectors 160.

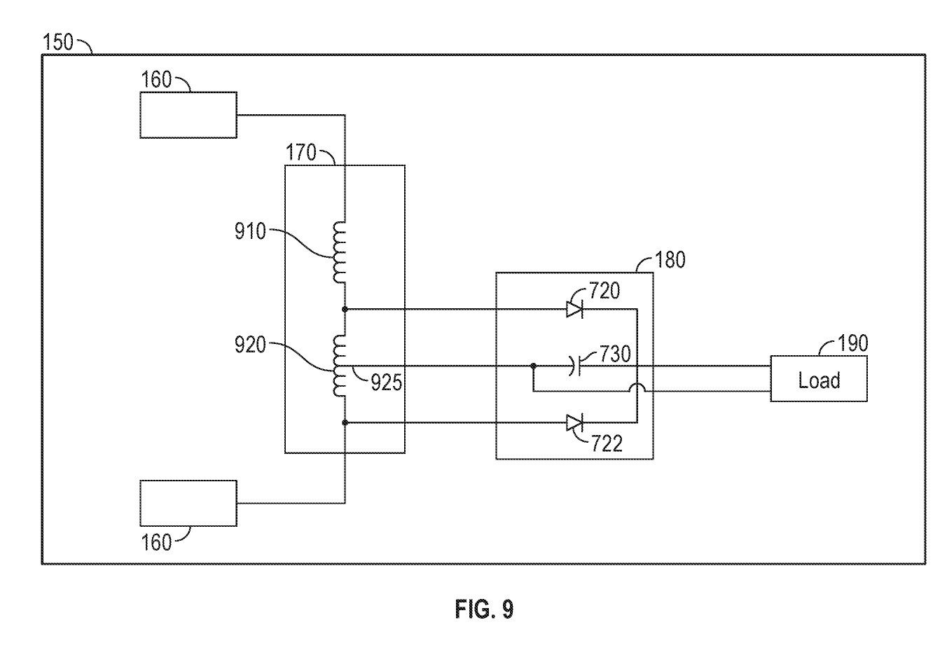

FIG. 9 is a diagram of a sink 150 according to another embodiment. This embodiment may be visualized as the embodiment of FIG. 7 with separate inductors 712 and 714 collapsed into a single inductor 920 with tap 925. As with the embodiment of FIG. 7, and advantage is obtained by coupling inductor 910 to inductor 920, such as by having inductors 910 and 920 stacked co-axially, for example on a double-sided or multi-layer printed circuit board. Harvesting electronics 180 in the form of a full wave bridge as used in FIG. 7 is connected to tapped inductor 920.

Note that in an embodiment such as that of FIG. 9, a collector 160 rather than being connected to the end of resonator 920 may be connected to the tap 925. Such an embodiment may be of use for example when part of the device circuitry such as a metal case or internal circuitry is used as collector 160.

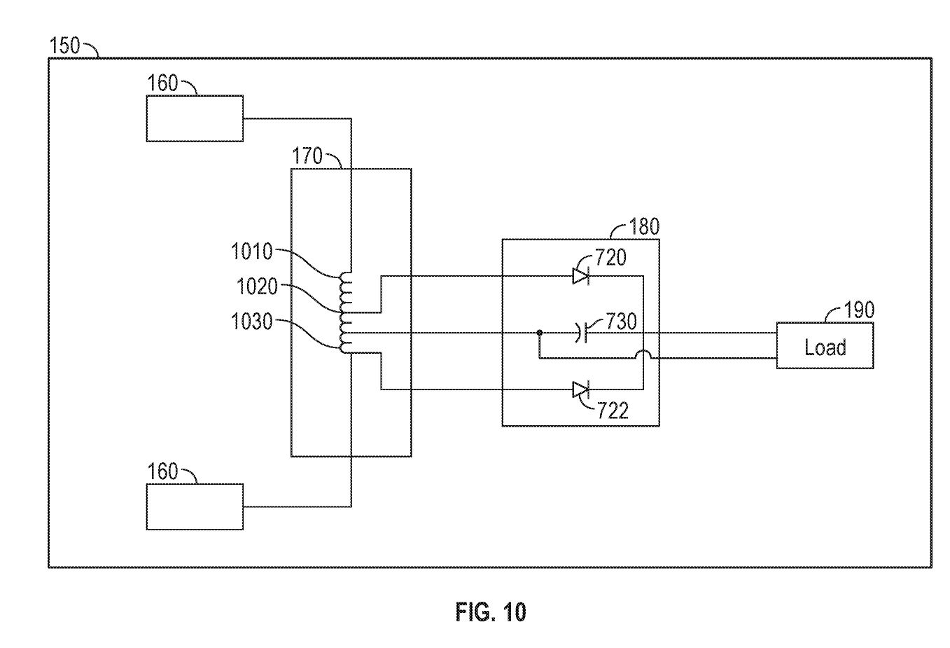

FIG. 10 is a diagram of a sink 150 according to another embodiment. This embodiment may be visualized as continuing the evolution of the embodiments of FIGS. 7, 8 and 9 by collapsing the separate inductors 710, 712, and 714 of FIG. 7 to a single inductor 1010 with multiple taps 1020, 1030. In this form, the full wave bridge of harvesting electronics 180 is connected to 1020, 1030 of inductor 1010. The positions of the multiple taps may be adjusted to tune the performance of the resonator, particularly in conjunction with collectors 160.

In practice, embodiments following FIGS. 6 through 10 may be fabricated using printed circuit techniques combining resonator 170 and harvesting electronics 180 on a single multilayer printed circuit board. Rigid substrates including but not limited to FR1, FR4, or Duroid®; or flexible substrates such as Kapton® may be used. As an example, a 4 layer printed circuit board implementing an embodiment according to FIG. 9 was fabricated on FR4, integrating 592 mm long inductors 910 and 920, PMEG6020ETR diodes 720 and 722, multiple ceramic capacitors 730, and positions for a linear voltage regulator and light emitting diode. This assembly measures approximately 10 by 35 millimeters. Another multilayer circuit board was fabricated on FR4, integrating 30525 mm long inductors 910 and 920, PMEG6020ETR diodes 720 and 722, multiple ceramic capacitors 730, and a light emitting diode. This assembly measures approximately 155 by 155 millimeters.

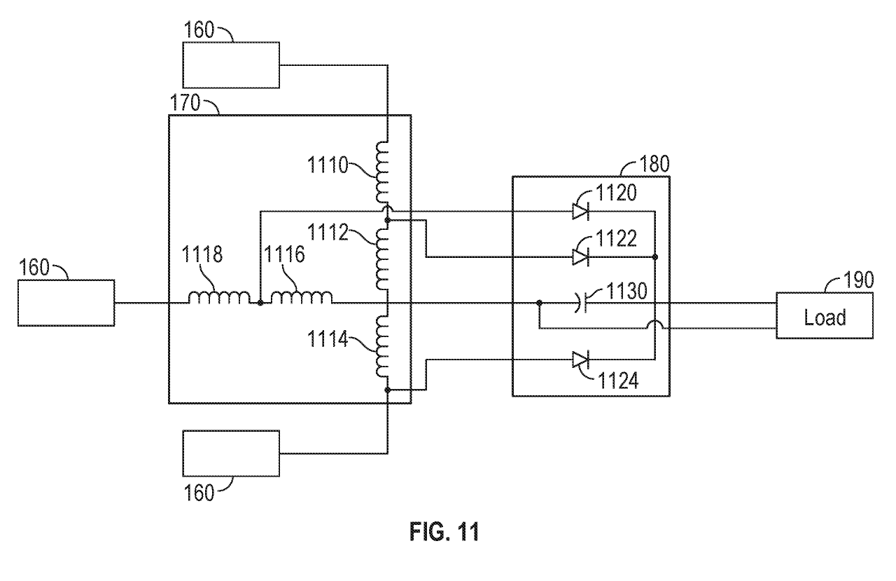

FIG. 11 is a diagram of a sink 150 according to another embodiment. In this embodiment, inductors 1110, 1112, 1114 correspond to inductors 710, 712, and 714 respectively of FIG. 7. Diodes 1122 and 1124 in harvesting electronics 180 similarly correspond to diodes 720, 722 of FIG. 7. The junction of inductors 1112 and 1114 is the common point for the full wave bridge in harvesting electronics 180. Inductors 1116 and 1118, with an additional collector 160 are added to this common point, with added diode 1120 in harvesting electronics 180. The modifications described in FIGS. 8 through 10 may be applied to this embodiment, such as by combining inductors 1110 and 1112 into a single tapped inductor, and/or combining inductors 1116 and 1118 into a single tapped inductor. Note that inductors 1116 and 1118 do not have to be co-planar or co-axial with inductors 1110, 1112, 1114.

Harvesting electronics 180 is diagrammed in FIG. 6. In this embodiment, a half-wave rectifier with diode 620 and filter capacitor 630 converts RF from collectors 160 and resonator 170 to DC for load 190. A full wave rectifier may also be used to convert RF from collectors 160 and resonator 170 to DC for load 190. In an embodiment, filter capacitor 630 is a 10 microfarad (uF) ceramic capacitor. A smaller value capacitor may be used as long as the value is adequate to remove ripple as is known in the art. Larger value capacitors are used to provide energy storage. Multiple capacitors may be used, for example multiple ceramic capacitors in parallel to increase energy storage, or one or more ceramic capacitors to provide ripple reduction coupled to a larger value electrolytic capacitor to provide energy storage. In one embodiment, a 10 uF ceramic capacitor is placed in parallel with a 0.1 F supercapacitor for energy storage. In another embodiment multiple capacitors ranging from 1 to 22 uF are placed in parallel.

It should be noted that diodes and/or bridges used in harvesting electronics 180 should be efficient at the RF frequency ranges used by the system. In practice, this requires the use of fast diodes with low reverse recovery times (Trr). An example of a suitable diode is the PMEG6020ETR from NXP Semiconductor with a Trr of 8.5 nanoseconds (ns). An example of a full-wave bridge is the NMLU1210 hybrid full-wave bridge from On Semiconductor.

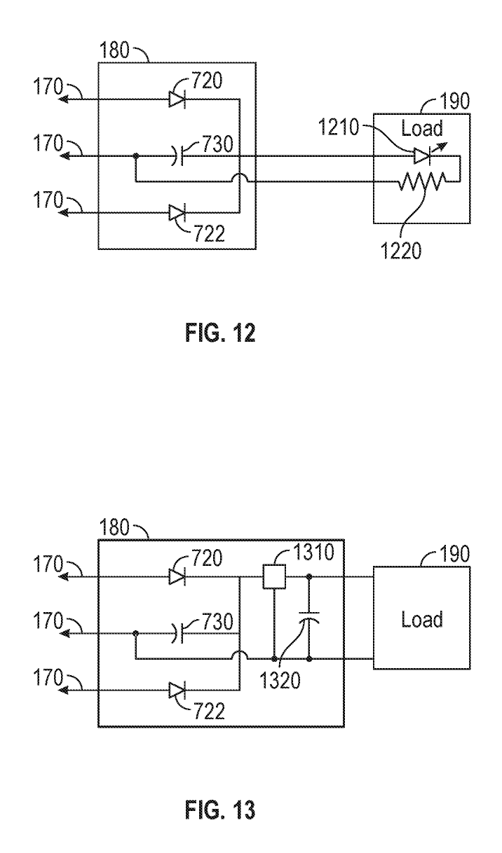

FIG. 12 is a diagram of harvesting electronics 180 and a load 190 according to an embodiment. Harvesting electronics 180 comprises a full wave rectifier using diodes 720 and 730 feeding capacitor 730 as shown in FIG. 7. As previously stated, capacitor 730 may be one or more capacitors to provide ripple reduction and energy storage. Load 190 in this embodiment is a light emitting diode (LED) 1210 and current limiting resistor 1220. A plurality of LEDs may be used. Depending on the output voltage available from harvesting electronics 180, a plurality of LEDs each with a current limiting resistor may be placed in parallel when a low output voltage is available with sufficient current to operate multiple LEDs. A series-connected string of LEDs with a single current limiting resistor may be used when the output voltage of harvesting electronics 180 is high enough to support such a configuration. It should be noted that this simple configuration according to FIGS. 7-9 may be made physically small, on the order of 10 to 15 mm on a side, not including collectors 160, providing for wireless operation of LEDs.

FIG. 13 is a diagram of harvesting electronics 180 according to another embodiment. In this embodiment, the bridge rectifier comprising diodes 720 and 722 feeding capacitor 730 then feeds a voltage regulator 1310 with optional output capacitor 1320. Such an embodiment is used where a regulated voltage is required for a load. Without voltage regulator 1310, such as with the harvesting electronics of FIGS. 7-11, the output voltage may vary considerably, and may exceed the maximum voltage for a particular load device. As examples, an electronic device such as a smart watch or phone may require a regulated 5 Volts to charge its internal batteries, and may be damaged by voltages above 5.5 volts. Voltage regulator 1310 provides a regulated output voltage for load 190. Voltage regulator 1310 may be a simple low-dropout regulator such as the MIC391xx series from Micrel Semiconductor, NCP1117 series from On Semiconductor, or other voltage regulators. Some of these regulators require an output capacitor 1320 for stability. A switching converter such as a single-ended primary inductor (SEPIC) converter may also be used for voltage regulator 1310. As is known in the art, a SEPIC converter topology produces a fixed output voltage for an input voltage which may be below or above the out voltage, where a low dropout regulator requires an input voltage greater than the output voltage.

In another embodiment of FIG. 13, particularly for driving LEDs, regulator 1310 is a constant current source. As is known in the art, constant current sources are preferred for driving LEDs. Regulator 1310 may be a linear constant current source or a switching constant current source. Constant current sources suitable for driving LEDs are available from many integrated circuit companies, such as Texas Instruments.

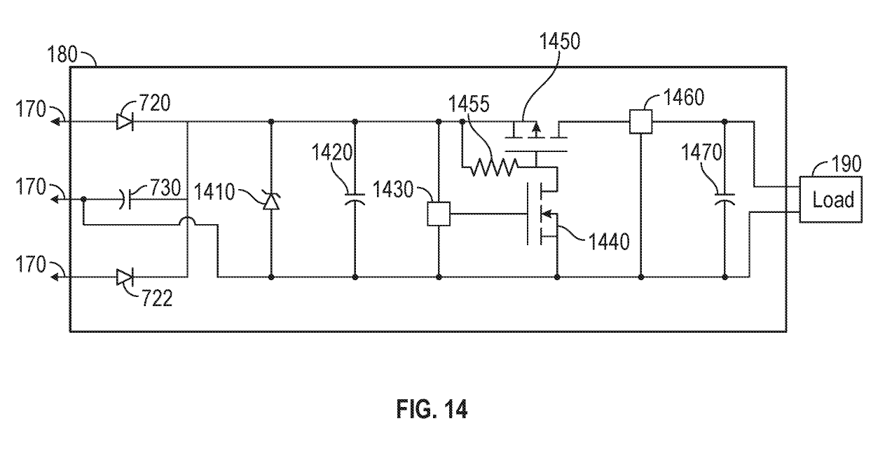

FIG. 14 is a diagram of harvesting electronics 180 according to another embodiment. In this embodiment, diodes 720 and 722 coupled to capacitor 730 provide filtered DC. Optional Zener diode 1410 conducts when the voltage across it exceeds the Zener rating, this insuring that the DC voltage at this point does not exceed the Zener voltage. The Zener voltage is determined by the maximum voltage allowed by the remaining circuitry. In an embodiment, a 12 Volt Zener may be used. Capacitor 1420 provides energy storage. In an embodiment, capacitor 1420 may be a plurality of capacitors in parallel, and/or large value capacitors such as supercapacitors. In an embodiment, capacitor 1420 is a 0.1 Farad capacitor. In another embodiment, capacitor 1420 may be replaced with a battery and supporting charge circuitry not shown, such as a rechargeable Lithium battery. The maximum charge voltage of such a battery will then determine the Zener voltage required for Zener diode 1410. Voltage sensor 1430 in combination with transistors 1440, 1450, and resistor 1455 form a switch which turns on transistor 1450, supplying stored energy from capacitors 730 and 1420 to regulator 1460 when the threshold voltage of voltage sensor 1430 is exceeded. In an embodiment, transistor 1440 is an N-channel field effect transistor (FET) such as a 2N7000 or 2N7002; similar components may also be used. Transistor 1450 is a P-channel FET. In an embodiment, P-channel FETs such as the FDN340P, IRF9Z10, IRLM6401, or similar components may be used. In an embodiment, voltage sensor 1430 is a STM1061N34WX6F from ST Microelectronics.

When the voltage across voltage sensor 1430 exceeds the 3.4 Volt operating threshold, the output of voltage sensor 1430 goes high. This turns on transistor 1440, pulling the gate of transistor 1450 low, allowing current to flow from capacitors 730 and 1420 to regulator 1460. This switching action allows charge to be accumulated in capacitors 730 and 1420, only enabling regulator 1460 when a sufficient charge is available. Regulator 1460 may be a low-dropout regulator or a switching regulator such as a SEPIC converter; such regulators are known in the art and will be determined by the requirements of load 190. An embodiment according to FIG. 14 was constructed on a multilayer printed circuit board measuring approximately 9 mm by 50 mm and used to charge smartphones, delivering up to 400 milliamps (mA) at 5 Volts DC.

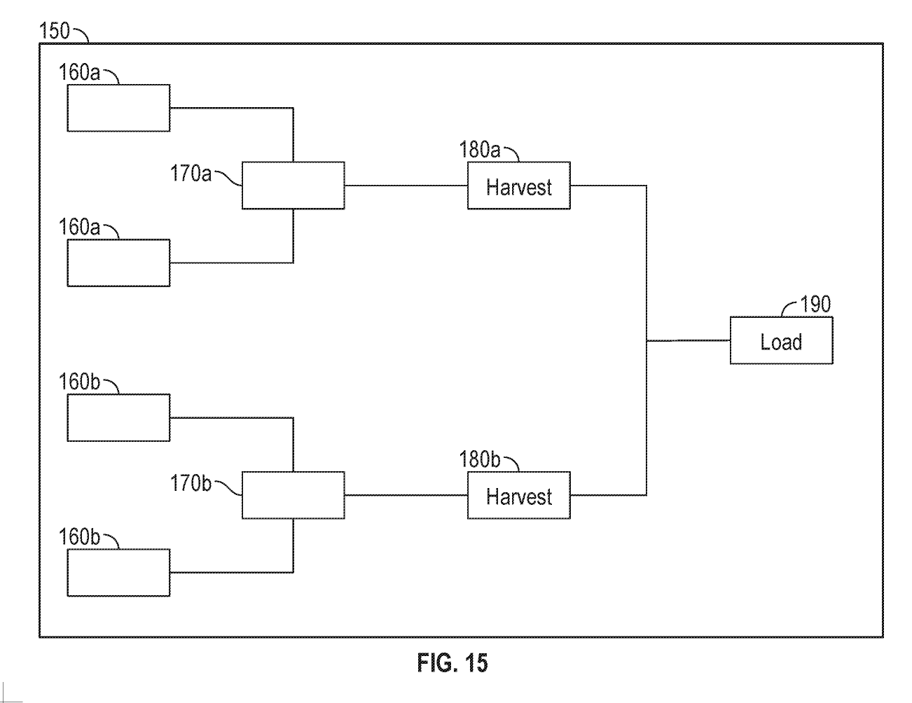

FIG. 15 is a diagram of supplying power to a load 190 according to an embodiment. As shown, collectors 160a are coupled to resonator 170a which is coupled to harvesting electronics 180a. Similarly, collectors 160b are coupled to resonator 170b which is coupled to harvesting electronics 180b. The DC outputs of harvesting electronics 180a and harvesting electronics 180b are combined to power load 190. The DC outputs of harvesting electronics 180a and 180b may be combined electrically in series to provide a higher voltage to load 190, or the DC outputs of harvesting electronics 180a and 180b may be combined electrically in parallel to provide a higher current to load 190. This configuration may be expanded with additional sets of collectors, resonators, and harvesting electronics. Such configurations allow smaller amounts of harvested energy to be combined to operate a load 190.

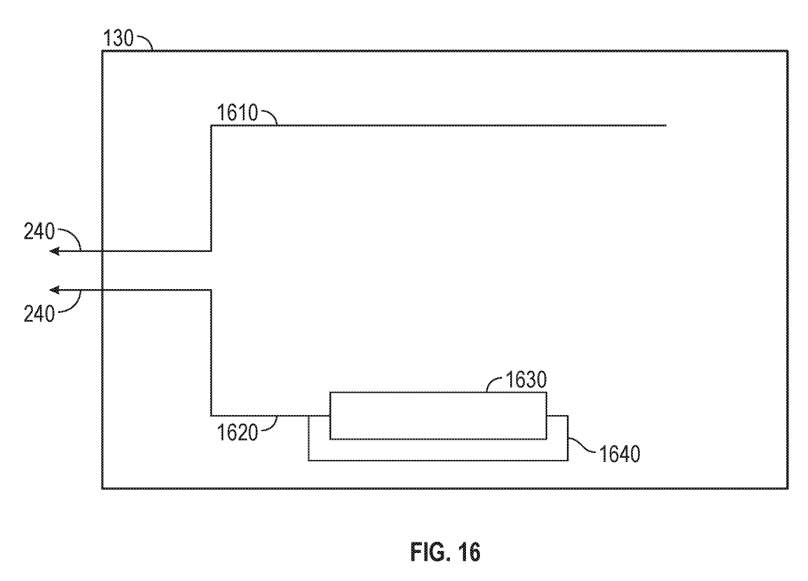

FIG. 16 is a diagram of an emitter 130 according to another embodiment. In this embodiment, emitter 130 comprises two conductors 1610 and 1620 coupled to the output 240 of the power generator 120 of FIG. 1. At least one conductor 1620 is coupled to a charge mobility element 1630. Optionally, the ends of the charge mobility element may be connected together as shown with jumper 1640. Charge mobility element 1630 may be directly connected to conductor 1620, or it may be capacitively coupled to conductor 1620. In an embodiment, conductor 1620 is approximately one meter in length. In an embodiment, charge mobility element 1630 may be a small fluorescent lamp such as an F8T6, F8T5, or a circular fluorescent lamp. The lamp may or may not illuminate during operation.

The embodiments shown enable power transfer to a wide range of devices, ranging from wearables such as rings, smart watches, fitness trackers, and the like, to smart phones, tablets, Internet of Things (IoT) devices and more.

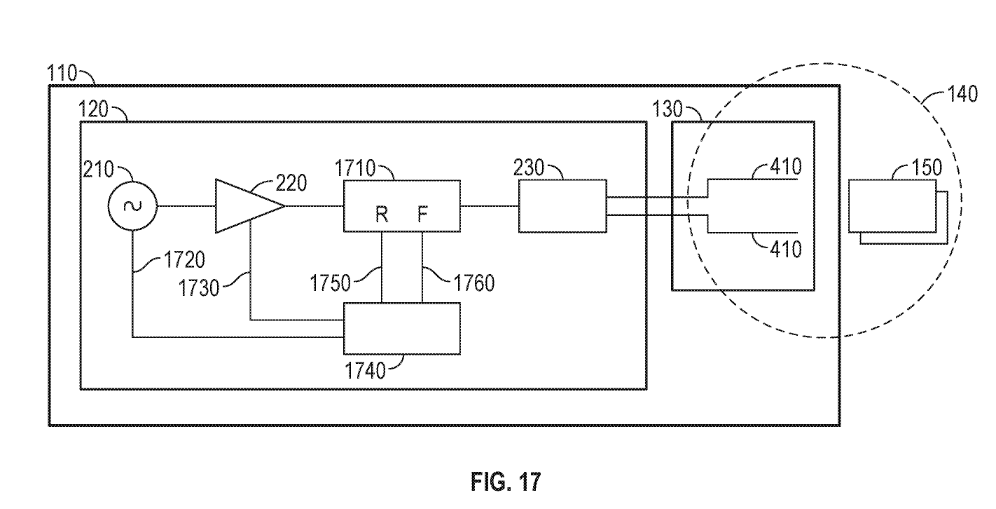

FIG. 17 is a diagram of a source 110 and one or more sinks 150 according to another embodiment. As described herein, tuning of a source 110 to operate at a particular frequency, more specifically, adapting or adjusting matching network 230 of FIG. 17 to increase forward power and reduce reverse power to emitter 130. A measure of this tuning is the standing wave ratio (SWR), a calculation known in the art which is a function of measured forward power and measured reverse power. An SWR value of 1 indicates maximum forward power and minimum reverse power and optimum power transfer between RF power amplifier 220 and emitter 130. An SWR value of 1 is ideal and seldom observed. As reverse power increases, indicating a mismatch between RF power amplifier 220 and emitter 130 and a decrease in power transfer, the SWR value increases.

It has been observed that the SWR of an operating source 110 changes as sinks 150 are moved in and out of field 140. This change in SWR may be measured to adapt source 110 as a sensor, for example sensing the presence of sinks 150 within field 140.

As shown in FIG. 17, a directional coupler 1710 is coupled between RF power amplifier 220 and matching network 230. Directional couplers are known in the art and produce a signal representing reverse power 1750 and a signal representing forward power 1760. Directional couplers are easily constructed as is known in the art, or may be purchased from companies such as Mini-Circuits or Nortec RF.

By optionally using an emitter 130 with reduced charge mobility elements (not shown) coupled to conductors 410, SWR sensitivity of source 110 to the presence or absence of sinks 150 is increased, resulting in increased changes to SWR derived from reverse power signal 1720 and forward power signal 1730. These changes are measured by monitor 1740. In an embodiment, directional coupler 1710 produces signals representing reverse power 1750 and forward power 1760. These signals are measured by monitor 1740, for example using diodes to convert the voltages representing reverse power 1750 and forward power 1760 to DC voltages and measuring these voltages at the analog inputs to a microprocessor. In another embodiment, a specialized integrated circuit such as the AD8302 RF Gain and Phase Detector chip from Analog Devices may be used to convert these voltages to digital signals for processing by a microprocessor. Other integrated circuits such as the AD8307, AD8310, or similar integrated circuits from other companies may be used to convert reverse and forward power to digital values for use by a microprocessor.

In one embodiment, monitor 1740 monitors forward and reverse power from directional coupler 1710. As sinks 150 are moved in or out of field 140, these signals from directional coupler 1710 change. These changes may be used to detect the arrival of a sink 150 in field 140, or the departure of a sink 150 from field 140.

In another embodiment, these signals may be used to provide adjusting signals to a matching network 230 adapted to receive such adjusting signals. Such adjusting signals may be used, for example, to adjust matching network 230 to minimize reflected power.

In another embodiment, these signals may be used to provide adjusting signals 1720 to frequency generator 210 adapted to receive such adjusting signals. Such adjusting signals may be used, for example, to adjust the operating frequency of frequency generator 210 to minimize reflected power.

In another embodiment, these signals may be used to provide adjusting signals 1730 to RF power amplifier 230 adapted to receive such adjusting signals. Such adjusting signals may be used, for example, to increase the RF power produced by RF power amplifier 230 from a first low level, to a second higher operating level when a sink 150 is detected in field 140, and/or to reduce the RF power produced by RF power amplifier 230 from the second higher operating level to the first low level when no sinks 150 are detected in field 140. In an embodiment, adjusting signal 1730 may be used to disable the output of RF amplifier 220.

### Power Transmission

An objective of the invention is to transmit power to a load 190. Because of the design of the invention, the load may be powered via the sink electronics 150 or directly via the emitter 130. An example of power transmission via the sink 150 electronics is the charging or replacement of a battery or battery system in a device. Another example of power transmission via directly from the emitter 130 is the powering of a fluorescent tube. It will be apparent those familiar in the art that the applications described are not limiting, and that the system has broader use outside of these applications.

As used herein, a device refers to an electronic assembly such as a watch, smartphone, IoT device, or other electronic assembly which also includes a sink 150 with collectors 160, resonator 170, and harvesting electronics 180 adapted to power the assembly as load 190.

Battery operation of modern electronic devices is both a blessing and a curse; a blessing in that a wider range of devices can be operated without wired connections, but a curse in that many of these devices must be tethered to a charger to replenish the internal battery. For the end user, the battery never has enough capacity. For the designer, the battery never has enough capacity and takes up too much space in the device.

Device operation or charging using a wired connector is simple and efficient. Many devices are adapted to operate or charge by connecting them to ubiquitous Universal Serial Bus (USB) ports, which provide a nominal 5 Volts DC at up to 2 Amps. But such charging, or operation in devices that do not have batteries, requires not only a connecting cable, but also a connector on the device. For certain classes of devices, such as wearable devices (smart watches, fitness monitors, and the like) and devices exposed to the environment such as action cameras, a connector means there must be one or more holes in the device enclosure that are open to the environment and must somehow be sealed. Each hole in the device enclosure is another opportunity for water, dirt, and other contaminants to enter the device. Holes in the case are anathema to smart watches, wearable devices, and devices exposed to the environment. Eliminating holes eliminates complexity of the case and reduces opportunities for environmentally induced damage.

While inductive charging solutions such as transformer coupling or systems such as Qi or Powermat do not require connectors, they require precise and continuous positioning of the device with respect to the charger.

The wireless power transmission system disclosed herein allows for wireless charging and/or operation of devices. Using emitter structures such as those disclosed and described as FIGS. 4 and 5 allows for device charging and/or operation without requiring precision alignment. Devices 150 may be moved on an emitter 130 without abandoning the charging process. Multiple devices 150 may also be charged simultaneously.

Returning to FIG. 1, source 110 generates field 140 which is coupled to collectors 160 and resonator 170 of device 150. Harvesting electronic 180 coupled to resonator 170 provides power to load 190.

In experiments, collector 160, resonator 170 and harvesting electronic 180 such as those shown in FIG. 9 and described in detail herein have been built into smart watches and fitness devices to provide for charging and operation. In one experiment, resonator 170 and harvest electronics 180 occupy approximately 15 by 15 millimeters. Collectors 160 are formed by device components such as cases, straps, and packaging materials.

The wireless power transmission system 100 disclosed herein provides sufficient power to operate devices, such as a wireless mouse, wireless keyboard or the like; in such a case the emitter 130 may be built into a desktop or desk surface to power devices.

The wireless power transmission system 100 disclosed herein may also be used to charge or trickle charge devices such as smart watches, phones, tablets and the like. Devices 150 adapted to use the techniques disclosed herein charge without requiring a wired connection, when in sufficient proximity of an operating emitter 130.

It is important to note that multiple devices 150 may be charged and/or operated from a suitable emitter 130 driven by a single power generator 120.

Depending on the application, emitter 130 may be designed to support charging of a single device 150, or multiple devices 150. Emitters 130 such as those shown in FIGS. 4c and 4d are suitable for a single device 150, such as a smart watch, pendant, wearable devices, or the like. The collector assembly 1900 of FIG. 19 when used with an emitter 130 according to FIG. 4c allows for the device 150 using collector assembly 1900 to be placed on the emitter 130 of FIG. 4c in any orientation; collector 160a overlaps emitter 410a and collector 160b overlaps emitter 410b independent of orientation.

When supporting multiple devices, emitters 130 according to FIGS. 4a, 4b, 4e, 4f and 5 offer different degrees of positional independence. Emitter structures with largely linear features, such as FIGS. 4a, 4b, 4d, 4e and 5 allow for simple collector layouts such as that of FIG. 19 to be somewhat position independent. The emitter structure of FIG. 4f allows for a greater degree of position independence by providing a predetermined spacing between emitters in more than one orientation.

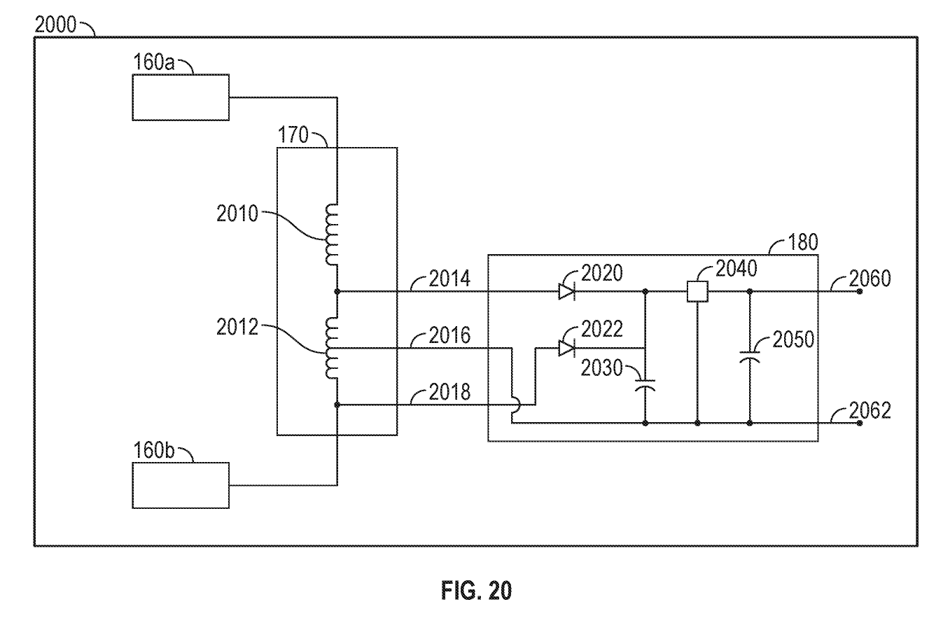

Another application of the charging and operation of an electronic device is battery replacement. FIG. 20 is a diagram of a battery replacement 2000 according to an embodiment. Collectors 160 connect to resonators 170 and harvesting electronics 180, providing DC power at terminals 2060 and 2062. In an experiment, a device according to FIG. 20 was constructed to replace a common AA-sized battery. Collectors 160a and 160b were formed using metal foil and placed on the cylindrical structure forming battery replacement 2000. Suitable 1.5 volt linear regulators for regulator 2040 are available from sources such as Texas Instruments and other semiconductor companies. Such a battery replacement 2000 will provide power to a device when battery replacement 2000 is within a field 140 of source 110.

Other embodiments may be constructed to replace other common sized batteries including but not limited to AA, C, D, 123A, and other cylindrical cells. Replacements for a pair of cells such as two AA cells in series may also be constructed in one enclosure the length of two AA cells and using a 3 Volt regulator. Replacements may be fabricated for rectangular batteries such as the popular 9 Volt PP3 package battery, also identified as ANSI/NEDA 1604.

While the embodiment of FIG. 20 shows two collectors 160a and 160b, an alternative embodiment can make use of the enclosing electronic device to provide one of the collectors. In such an embodiment, terminal 2062 which is connected to tap 2016 on resonator 2012 is considered one collector, and collector 160b is not used. In a replacement battery application, this allows collector 160a to take up more of the enclosure for the replacement battery.

In another embodiment, contacts may be placed on the replacement battery enclosure to couple resonator 170 to external collectors 160. In the case of an AA replacement, for example, two contacts are provided on the outer enclosure of replacement battery 2000. The receptacle for this replacement battery 2000 provides contacts to collectors 160.

In another series of embodiments, a rechargeable cell such as a lithium ion or lithium polymer cell (not shown) incorporates the circuitry of FIG. 20. In one such embodiment, resonators 170 and harvest electronics 180 are packaged with the lithium cell with separate connections brought out for coupling to collectors 160 and for coupling outputs 2060 and 2062 to charging circuitry external to the lithium cell.

In another embodiment, one or both collectors 160 may be associated with the lithium cell. This may include using one terminal of the lithium cell as a collector, as described elsewhere herein.

In another embodiment, regulator 2040 comprises lithium cell charging circuitry. In such an embodiment, resonators 170 and harvesting electronics 180 including charging circuitry are associated with the lithium cell. Additional terminals may be included for collectors 160 external to the lithium cell, or the collectors 160 may be included with the lithium cell. As described previously, the lithium cell and/or the surrounding electronics may be used as a collector 160. Such a replacement battery 2000 includes the lithium cell, collectors 160, resonators 170, and harvesting electronics 180 which further includes lithium cell charging circuitry 2040, thus charging the lithium cell when it is within field 140 of a source 110. Lithium cell charging circuitry may comprise for example the MCP73831 Charge Management Controller from Microchip Technology, Inc. Other suitable lithium charging chips are produced by Texas Instruments and other semiconductor companies.

The wireless power transmission source 110 disclosed herein may be used to directly energize a gas-filled vessel. Examples of gas-filled vessels used in experiments were fluorescent tubes, black light fluorescent tubes, ultra-violet fluorescent tubes, and neon sign tubes.

In an experiment, common fluorescent tubes illuminate when placed on or near an emitter 130 such as those shown in FIGS. 4 and 5. The illumination is partial and related to the space adjacent to emitter elements 410. Such illumination does not require the provision of ballast wiring, or any wiring to the fluorescent tube, to provide illumination. An initially higher RF power level may be required to initiate illumination, after which the RF power level may be reduced to a sustaining level. As an example, approximately 10 Watts of RF energy was required to initiate illumination in a typical FCT9 32 Watt circular fluorescent tube, or a 4-foot 32 Watt T8 or T9 tube, while 2 Watts was sufficient to maintain illumination. If lower initial voltage was used, then a collector 160, such as a person's hand contact on the tube, would be needed to initiate the illumination. Other gas-filled vessels such as neon tubes were also illuminated in this manner.

In wearable class devices, referring to FIG. 4a, the wearer's body may be used as an emitter 410 and/or charge mobility element 420. For example, a low-power rf generator 120 can capacitively couple into a human body through an emitter 410 covered with an insulator such as Kapton tape.

In an experiment, a single-line feed RF generator 120 according to FIG. 4b was coupled to an aluminum tape emitter 410 covered with Kapton tape. The experimenter placed his hand on the Kapton-covered emitter 410. In his other hand he held a sink as shown in FIGS. 6 through 9, using LEDs as a load. Holding the sink by one collector 160 and touching the other collector 160 to his arm touching the emitter 410 caused the LED to light, demonstrating transfer of power.

It should be noted that the system disclosed herein may be scaled up in power for use with larger devices.

### Data Transmission

The wireless power transmission system 100 disclosed herein may also be used for data transmission. Different embodiments provide for data transmission between a source and one or more sinks (devices), between a sink and a source, or among sinks sharing a common source.

An embodiment such as that shown in FIG. 1 may be used to transfer data from source 110 to one or more sinks 150 by modulating the signal produced by power generator 120. Various modulation schemes known in the art may be used. As an example, amplitude modulation of the signal coupled to emitters 130 may be detected at sinks 150. Similarly, frequency modulation, phase modulation, or more complex modulation schemes known in the art may be used, transferring data from source 110 to one or more sinks 150. Data and power may be transferred together. Where only data transfer is required, distances over which data transfer may be accomplished increase, as a data-only sink requires far less signal levels for only data decoding, as compared to the signal levels required for data plus power.

Given that the response of resonators 170 in a sink is a function of resonator length and geometry, frequency shift keying, that is, shifting the frequency of power generator 120 may be used to transfer data to a subset of sinks 150 in a system. As an example, assume that a first group of sinks 150 has a flat response (one where signal levels are about equal) at frequencies f1 and f2, and a very low response at frequency f3. Assume that a second group of sinks 150 has a flat response at frequencies f2 and f3, and a very low response at frequency f1. A single source 110 can thereby transmit data to the first group of sinks 150 by switching between frequencies f2 and f3, and can transmit data to the second group of sinks by switching between frequencies f1 and f2.

In experiments it was observed that as multiple sinks 150 of FIG. 1 are placed within the field 140 produced by an emitter 130, the voltage (and power) available to each sink 150 (or device including a sink 150) decreases. As sinks 150 are removed from field 140 or disconnected as loads 190 from their associated harvesting electronics 180, the voltage (and power) available to other sinks 150 within field 140 increases. This provides for data transmission from a sink to a source, or from a sink to additional sinks by switching the load at a sink. This technique is known as load modulation. It should be noted that this effect also allows for enumeration of sinks 150 within the field 140 produced by emitter 130, and detection of when sinks 150 are added to or removed from that field. Such enumeration and/or detection may be performed by source 120 measuring forward and/or reflected power to emitter 130, or by sinks 150 measuring the voltage or power available at the sink 150.

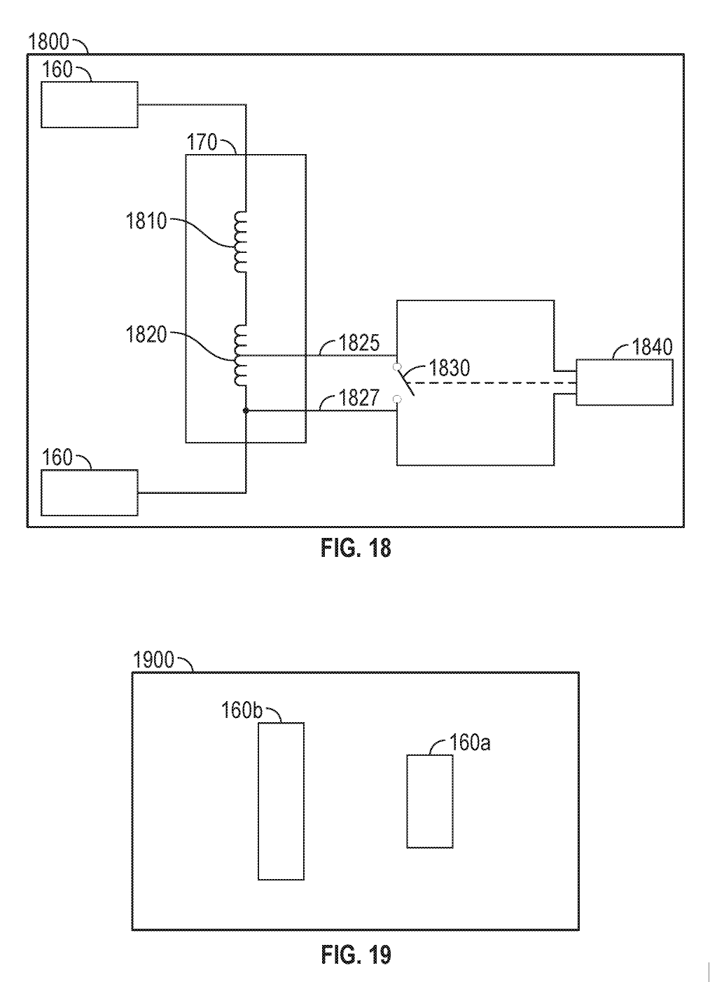

FIG. 18 shows a receiver unit 1800 or a data transfer device according to an embodiment in which data may be transferred from a sink 1800 to a source 110 as shown in FIG. 17, or from one sink 1800 to another sink 1800. In such an embodiment, source 110 of FIG. 17 provides a carrier on which sinks 150 modulate data.

As shown in FIG. 18, a sink 1800 adapted for data transmission comprises collectors 160, resonator 170, load switch 1830, and data controller 1840. This embodiment, with inductor 1820 and tapped inductor 1820 is similar to sink 150 of FIG. 9 discussed previously herein. In operation as a data transfer device, data controller 1840 coupled to switch 1830 causes switch 1830 to open and close in accordance with an encoding of the data to be transmitted. This technique is known in the art as load modulation. When switch 1830 is closed, additional load is placed on inductor 1820. This additional load is reflected back through collectors 160 as a change in the voltage present on emitters 130 of source 110. Referring to FIG. 17, this change in load is sensed at source 110 by directional coupler 1710 as a change in either or both of forward or reflected power. Since this change in the voltage present on emitters 130 is present on collectors 160 of all sinks 1800 present, load-modulated data generated by one sink 1800 is available to all sinks 1800. Thus, data may be transferred not only from one sink 1800 to source 110, but also from one sink 1800 to an another sink 1800 coupled to the same emitters 130.

While the embodiment shown depicts switch 1830 adding load between points 1825 and 1827 on inductor 1820 which is part of resonator 170, a switch 1830 may also be placed directly across collectors 160, or across any portion of resonator 170. In an embodiment switch 1830 is typically a field effect transistor (FET) switch. Other load switching arrangements known in the art may also be used.

Note that the data transmission methods may be combined. For example, a source 110 may transfer data to a sink, and then sense a reply from that sink using the methods described herein, for example, load modulation. A sink 1800 may detect load modulation by using, for example, the harvesting circuitry of FIG. 9, replacing load 190 with a sensor measuring voltage levels to decode changes produced by load modulation.

In a series of data transfer experiments, a source 110 was prepared which produces approximately 1 to 2 watts of RF power at 13.56 MHz, modulated by turning the RF signal on and off under microprocessor control. The device used to detect the signal was a collector—resonator assembly as shown in FIG. 9, connected to a Rhode and Schwarz FSH3 portable spectrum analyzer which replaces harvest electronics 180 and load 190.

In a first experiment, the source 110 was operated in an industrial building according to FIG. 4a, with output 420b connected to the electrical ground 430 of an industrial building through an electrical outlet. Output 420a was connected via a cliplead and a piece of copper tape to a cold water pipe near the electrical outlet providing power for source 110. The modulated signal is thus injected between the cold water pipe and the common electrical ground. No signal was detected on the spectrum analyzer with the collector-resonator in free air. Moving the collector-resonator along walls, signal was detected in areas corresponding to conduit and electrical wiring in walls, water lines in walls, and at electrical boxes including switches and outlets. Placing the collector-resonator on the concrete slab floor, signal was detectable in certain areas of the concrete, indicating metallic structures such as rebar. Signal was also detectable on metal shelving anchored to the concrete, and along exposed electrical conduit and electrical boxes.

A second experiment repeated the first experiment in a larger commercial facility. As in the first experiment, source 110 was coupled to a copper cold water pipe and powered from a nearby electrical outlet, thus injecting the signal between the cold water pipe and common electrical ground. Signal was detected using the collector-resonator connected to the portable spectrum analyzer through the commercial facility over a range of over a hundred meters on electrical boxes such as switches and outlets, and on metal structures. No signal was detected when the collector-resonator was held in free air.

A third experiment repeated the first and second experiments in a residential setting. As in the first and second experiments, source 110 was coupled to a copper cold water pipe and powered from a nearby electrical outlet, thus injecting the signal between the cold water pipe and common electrical ground. Signal was detected using the collector-resonator connected to the portable spectrum analyzer through the residence, following electrical wiring and plumbing. Signal was also detected on an outside electrical outlet of an adjoining residence which receives electrical power through the same utility transformer. No signal was detected when the collector-resonator was held in free air.

A wide range of data may be transferred between and among sources and sinks. As an example, a source may signal its capabilities to sinks. Sinks may signal identifying information, such as model identification, serial number, or device state. Sinks may also signal data sensors connected to the sink. As an example and without limitation, a simple microprocessors suitable for use in a sink such as the Atmega 328 from Atmel, or a Cortex M0, support analog and digital input/output, as well as standard interconnects known in the art such as I2C. Examples of sensors include temperature, humidity, light levels, acceleration, magnetic fields, and more.

### Sensors

In applying the present invention to sensors, the term devices, specifically referencing device 150 in FIG. 17, again defined as assemblies containing sinks, and as charge mobility element, such as a person, or a conductive solution such as a salt solution, for example. As demonstrated through experiment and described herein, changing the quantity and/or positions of devices 150 within a field 140 of an active emitter 130 changes the voltage and power available at each device 150, and also changes the balance of forward and reflected power presented to power generator 120 and measured by directional coupler 1710. These changes are also caused by changes in the collector/resonator structure of devices 150. These changes can be used to sense changes in the environment including power generator 120, emitter 130, and devices 150.

In one embodiment, by monitoring forward and reverse power such as shown in FIG. 17 and described herein, power generator 120 can sense when devices 150 enter and/or leave field 140, and can characterize those devices.

As an example, a certain set of forward and reverse power readings from directional coupler 1710 made by monitor 1740 indicate no devices 150 are present within field 140. In such a case, RF power from power generator 120 may be controlled via signal 1730 to produce RF bursts periodically so that the presence of a device 150 entering field 140 may be detected, but RF power is not supplied constantly. In an embodiment and depending on the implementation of power generator 120, bursts on the order of milliseconds may be sufficient for device detection.

When a device 150 is detected, RF power from power generator 120 may be switched on continuously. Changes in forward and reverse power readings are monitored by monitor 1740. Actions may be taken on devices 150 entering or leaving field 140, as signaled by changes in these forward and reverse power readings.

Devices 150 may be validated using a number of approaches. One approach uses the data communications capabilities described herein. In an embodiment, power generator 120 on sensing a device 150 entering field 140 transmits an inquiry and listens for a response. A response or the lack of a response can be used by monitor 1740 to recognize an authorized device 150 and/or to distinguish a device 150 from an intrusive object such as a metal object placed on emitter 130. Devices 150 may be authenticated based on class, as a group, or as individual devices.

Authentication as described, requiring device 150 to transmit responsive data to power generator 120, requires intelligence such as a microprocessor in device 150. This may not be desired for various reasons including but not limited to cost.

Another approach to device identification relies on the frequency response of resonators 170 as described elsewhere herein. When monitor 1740 detects a possible device 150 within field 140 based on changes in forward and reflected power levels from directional coupler 1710, monitor 1740 commands signal generator 210 to generate different frequencies via signal 1720, monitoring forward and reflected power levels from directional coupler 1710 to identify the frequency response of a valid resonator in a device 150. The frequency response of such a resonator, as measured by forward and reflected power levels will be different from that of an obstruction such as a metal pie plate.

Probing the frequency response of devices 150 in field 140 can identify devices by class, by group, or individually, and also detect obstructions.

The frequency response measured at monitor 1740 in source 110 is the frequency response of the ensemble of all devices (sinks) 150 within field 140. This frequency response changes with the number of such sinks 150 and the loads on each. Changes in this frequency response, therefore, indicate changes in the ensemble of all devices 150.

Identification of the number of devices 150 present in field 140 through monitoring forward and reverse power may be used to adjust the RF power delivered by power generator 120 to emitter 130. This may be useful in environments where RF power may be scaled to meet the requirements of different numbers or types of devices 150.

Another sensor application relies on the frequency response sensitivity of collector and resonator structures. Such structures can be made sensitive to position of individual elements. Arranging a number of devices containing such structures along a single-line emitter feed results in a system where changes to any of the devices 150 may be sensed as changes in forward and reverse power levels in power generator 120. Such changes may be caused by objects or people moving near devices 150, changes in the positions or orientation of devices 150 relative to emitter 130, or the like.

Another sensor application relies on the frequency response sensitivity of collector and resonator structures built into a device to detect tampering with the device.

As an example, a collector, resonator, harvester structure is built into a device, with points on the resonator and harvester structure made available outside the device through connection points. Performing a frequency sweep of the collector, resonator, and harvester structure will produce an identifiable frequency response spectrum which may be treated as a device fingerprint. Opening the device or causing changes in the positioning of the collector, resonator, and harvester structure will alter this frequency response spectrum and the device fingerprint. Periodic rescanning of the device and comparison of its current device fingerprint with a previously known good device fingerprint can detect tampering.

As is understood in the electronic arts, current flowing through a conductor generates a magnetic field which affects other conductors within the field. By placing current carrying conductors near a resonator, the response of that resonator will be altered by the current flowing through those conductors. This produces a frequency response spectrum forming a dynamic device fingerprint based on dynamic operating characteristics of the device. Changes in the current carried by those conductors near a resonator will change this dynamic device fingerprint, allowing for the detection of tampering with the operational characteristics of the device, which may include the software in a programmable device.

### Resonator Structures

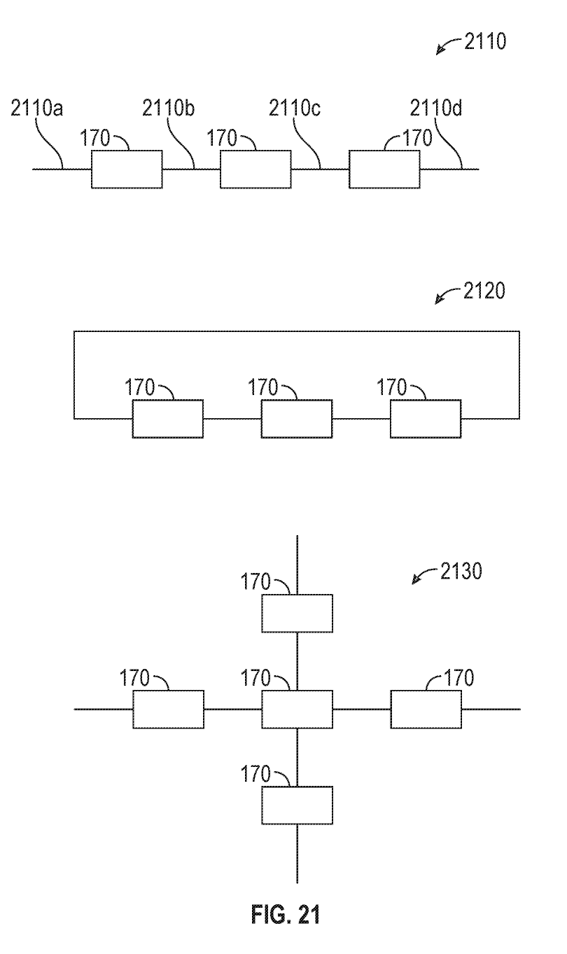

An aspect of the invention comprises of one or more sets of electrically conductive windings, referred to in the preceding discussions as resonators. These resonators are of various configurations, ranging from planar circular to 3 dimensional rectangular, as examples. Within a resonator-set, individual resonators are connected in series with each other. The distance between the individual resonators may be a fractional resonator diameter from each other. The resonators within the resonator-set may be arranged in various configurations as shown in FIG. 21, from open or closed looped linear 2110, 2120, to open or closed looped circular extending resonator-sets 2110 and 2120 into a curved or circular form, and/or to a three-dimensional form. The number of resonators 170 in each resonator set may be increased from the numbers shown. Another example is the cross 2130. These and other configurations such as spiral arrangements of resonators 170, as examples, have demonstrated a wide spectrum receiver response. The resonator and resonator-set configurations do not need to match each other in shape, size or the quantity of resonators in an overall system.

The term node not only refers to points between two adjacent resonators, but nodes may span multiple resonators within the resonator-set. As an example, in the 3 resonator-set 2110, the nodes are labeled 2110a, 2110b, 2110c, and 2110d.

Collectors may be attached to nodes, such as shown for example in FIGS. 6-11. In FIG. 21, collectors may be attached to nodes 2110a, 2110b, 2110c, and/or 2110d. As described previously herein, the collector need not be a good conductor. Tests have shown that a spray conductor, such as carbon conductive coating, on plastic sufficed for system operation in power transfer, data transfer, and sensor applications. Using pyrolytic carbon for the collector, and in general using materials that minimize the volume magnetic susceptibility for the collector, makes the relative permeability tend toward zero. Pyrolytic carbon has a negative volume magnetic susceptibility, thus improves power transfer efficiency.

The physical location of the collector and its attachment point is important. The closer the collector is connected to a node, the larger the voltage potential at that node. The placement and size of the collector may be used for tuning the resonator-set. Many resonator-sets can share collectors to eliminate the need for an individual collector for each resonator-set. Alternatively, a sink can greatly increase its sensitivity by adding additional collectors to the resonator-set. Noticeable change also occurred with not only changing the area, but the volume of the collector. The size, surface area and volumetric displacement, of the collector affects the voltage potential across a node. However, the function of the collectors does not seem to be sensitive to its conductivity.

For the resonator-set in a sink, a collector can be floating or capacitively grounded, that is capacitively coupled to ground.

Spanning the physical distance between the resonator-set is a conductive path. This path need not touch any of the resonators in the resonator-set, but terminates within a resonator length of any of the individual resonator within the resonator-set. The resonator-set and the path may be electrically insulated from each other. Thus the resonator-set and the conductive paths are electrically floating with respect to each other. The conductive path makes capacitive and/or inductive coupling to one or more points with the resonator-sets. However, the invention also works with the conductive path making electrical contact to one or more resonators within the resonator-sets. The material for this conductive path may be of any conductive material, ranging from good conductors such as metals (copper, iron, and the like), to less conductive materials such as the collector materials described previously herein, to ionic conductors such as saltwater. Although the conductive path is not essential to the function, the signal transmission strength is greatly increased.

A voltage potential exists between any two resonators within the resonator-set. The voltage depends on the signal frequency, injection location, conductive material contact location and resonance of that node. Placing multiple loads at varied nodes may be used to increase total load within the resonator-sets.

In an experiment, a range of different configurations of the resonators and resonator-sets were tested, ranging from open linear to closed circular to spiral to cross. Expanding on the system diagrams of FIGS. 1 and 17, FIG. 22 shows two configurations tested.

The system configuration shown in 2210 shows a single line feed from source 120, with one output of source 120 connected to ground 2218 and the other output driving emitter 130 and conductive path 2215. The coupling between emitter 130 and conductive path 2215 may be a direct electrical connection, or the coupling may be capacitive. Sink 150 is coupled to conductive path 2215. In one embodiment one collector 160 of sink 150 may be connected to ground. Resonator 170 in sink 150 may be replaced by a resonator-set as described herein.

As described previously herein, conductive path 2215 may be a good conductor such as a metal tape, or it can be a path such as that formed by the electrical wiring in a building, the conduit in a building, conductive piping or ducting in a building, rebar in concrete structures, other conductive features in the local environment, and combinations of these.

The system configuration shown in 2220 shows a balanced feed with source 120 driving resonator 170 which couples to conductive path 2215. Sink 150 couples to conductive path 2215. In variations on this embodiment, resonator 170 connected to source 120 may be a resonator-set as described herein. An emitter 130 may be coupled to ground. A collector 160 in sink 1650 may be coupled to ground.

In an experiment using a resonator-sets according to FIG. 21 as described herein, multiple high efficiency red and green light emitting diodes (LEDs) were connected between various nodes of the resonator set. Bringing a collector 160 near or in contact with conductive path 2215 caused the LEDs to light at various intensities.

In a set of experiments the individual resonators in the resonator-set comprised 4 meter length traces in a planar spiral configuration covering approximately 1.75×1.75 cm on a fiberglass substrate. A minimum of one resonator to a maximum of 144 resonators per set were tested, with various configurations of arrangements of the resonators. One resonator-set comprised a circuit board with twelve 3×1 planar resonators wired in series. Another resonator set comprised 36 such resonators connected in series with each other.

The resonator-set was connected to the input port of a BK Precision Spectrum Analyzer to serve as sink 150. Note that the Spectrum Analyzer provides a 50 Ohm load to the resonator-set. By sweeping the operating frequency of source 120 while observing the output of the resonator-set, a slight resonance at 15.45 MHz was observed as a peak on the Spectrum Analyzer display, while showing good signal levels over a wide frequency range. This resonance gave nearly constant to linearly decreasing efficiency as a function of range between the source emitters, conductive path, and the sink comprising the resonator-set and spectrum analyzer. The dominant power loss was insertion loss only. One collector was attached to the Tx and one collector was attached to the Rx.

A collector comprising a square foot piece of plastic sprayed with a layer of MG Chemical Total Ground Carbon Conductive Coating was used. A second collector comprising about five gallons of salt water collector at about 1.2 specific gravity (sg) was used. A human body was also used as a collector.

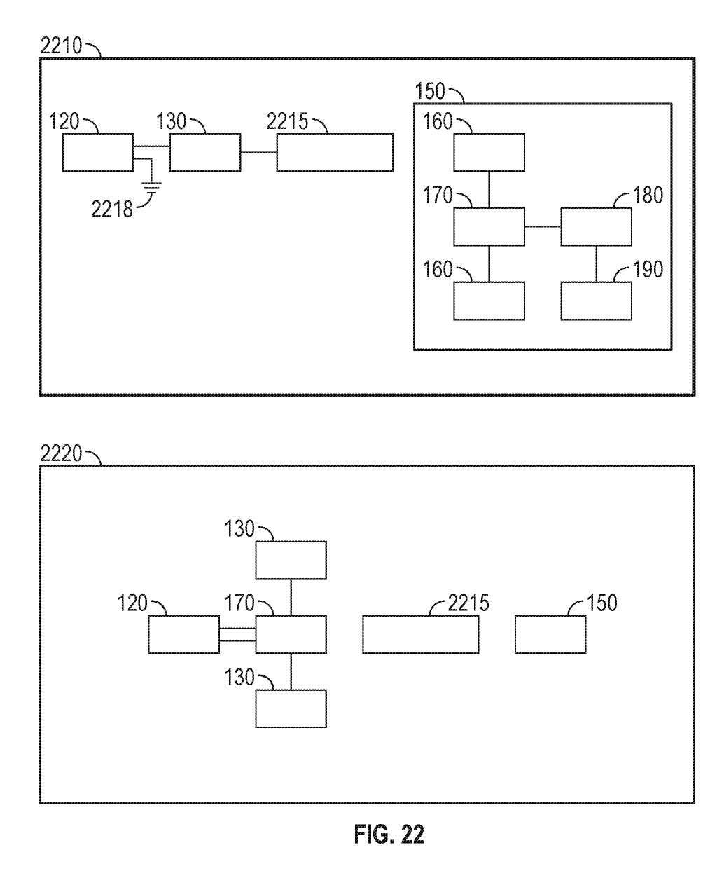

The input frequencies for source 120 were produced by a BK Precision 4040A Function Generator similar to 2210 of FIG. 22. Voltage was set to the Function Generator's maximum output voltage for the specific frequencies generated; set at approximately 10V peak to peak (Vpp).

These tests show that electrically small planar boards can be constructed without primaries and exhibit nearly constant to linearly decreasing efficiency as a function of source to sink range. However, a non-linear scaling of reduction in frequency and broadband spectrum occurs with the increase in the number of resonators within the resonator-set.

The disclosed method and apparatus have been explained herein with reference to several embodiments. Other embodiments will be apparent to those skilled in the art in light of this disclosure. Certain aspects of the described method and apparatus may readily be implemented using configurations other than those described.

It is to be understood that the examples given are for illustrative purposes only and may be extended to other implementations and embodiments with different conventions and techniques. While a number of embodiments are described, there is no intent to limit the disclosure to the embodiment(s) disclosed herein. On the contrary, the intent is to cover all alternatives, modifications, and equivalents apparent to those familiar with the art.

In the foregoing specification, the invention is described with reference to specific embodiments thereof, but those skilled in the art will recognize that the invention is not limited thereto. Various features and aspects of the above-described invention may be used individually or jointly. Further, the invention can be utilized in any number of environments and applications beyond those described herein without departing from the broader spirit and scope of the specification. The specification and drawings are, accordingly, to be regarded as illustrative rather than restrictive. It will be recognized that the terms “comprising,” “including,” and “having,” as used herein, are specifically intended to be read as open-ended terms of art.

We claim:

1. A sensor system comprising:
a source producing RF power,
a coupler for coupling the RF source to one or more emitters producing a field, the coupler measuring the coupling between the RF source and the emitters,
and
a controller measuring the coupling between the RF source and the emitters to detect changes in the field.

2. The sensor system of claim 1 where the coupler measures forward RF power.

3. The sensor system of claim 1 where the coupler measures reverse RF power.

4. The sensor system of claim 1 where the controller detects changes in the field by detecting changes in the coupler measurements.

5. The sensor system of claim 4 where the changes in the coupler measurements are made at a fixed frequency.

6. The sensor system of claim 4 where the changes in the coupler measurements are made at a plurality of frequencies.

7. The sensor system of claim 4 where the changes in the coupler measurements are made by comparing measurements to measurements made in a known state.

8. The sensor system of claim 1 where the emitters are placed inside a structure for detecting changes made to the contents of the structure.
